(19) United States
(12) Patent Application Publication
(10) Pub. No.: US 2001/0010261 A1
(43) Pub. Date: Aug. 2, 2001

(54) Vehicle air conditioner with reduced fuel consumption of vehicle engine

(76) Inventors: Mitsuyo Oomura, Hekinan-city (JP); Yuji Takeo, Toyoake-city (JP); Eiji Takahashi, Toyohashi-city (JP)

Correspondence Address: H. Keith Miller, Esq., P.O. Box 828, Bloomfield Hills, MI, 48303, US

(21) Appl. No.: 09/767,193

(22) Filed: Jan. 22, 2001

(30) Foreign Application Priority Data
Jan. 28, 2000 (JP) 2000-24784

(51) Int. Cl. B60H 3/00; B61D 27/00; F24F 3/14; F24F 6/00

(52) U.S. Cl. 165/42; 165/43; 165/222

(57) ABSTRACT

In an air conditioner for a vehicle having an engine that is temporarily stopped when an engine power is unnecessary, when an engine operation request signal from the air conditioner is output, the engine is operated to drive a compressor so that pleasant performance of a passenger compartment can be obtained. On the other hand, when the engine operation request signal from the air conditioner is not output, a determination level whether or not the compressor operates is changed so that a stop range of the engine is enlarged, while the pleasant performance of the passenger compartment is set in a suitable range. Accordingly, the pleasant performance of the passenger compartment is improved while fuel economy performance of the engine is improved.

### CROSS-REFERENCE TO RELATED APPLICATION

This application is related to and claims priority from Japanese Patent Application No. 2000-24784 filed on Jan. 28, 2000, the contents of which are hereby incorporated by reference.

### BACKGROUND OF THE INVENTION

1. Field of the Invention

The present invention relates to an air conditioner for a vehicle in which a vehicle engine temporarily automatically stops and a compressor of a refrigerant cycle is driven by the vehicle engine. In the vehicle air conditioner, a fuel consumption of the vehicle engine is reduced.

2. Description of Related Art

In a conventional vehicle air conditioner described in JP-A-7-179120, an air-conditioning control is performed based on a humidity of air in a passenger compartment and a humidity of air on a windshield so that the humidity of air is suitably controlled to improve defrosting performance of the windshield and pleasant performance of the passenger compartment. However, when the vehicle air conditioner is applied to an economically running vehicle (hereinafter, referred to as “eco-run vehicle”) where a vehicle engine automatically stops when the vehicle stops, or a hybrid vehicle having both a vehicle engine and an electrical motor for vehicle-travelling, it may be difficult to obtain pleasant performance of the passenger compartment and defrosting performance of the windshield, while the characteristics of the eco-run vehicle and the hybrid vehicle are obtained.

### SUMMARY OF THE INVENTION

In view of the foregoing problems, it is an object of the present invention to provide an air conditioner for a vehicle having a vehicle engine which temporarily stops in a case where an engine power is unnecessary, such as a vehicle stop. In the air conditioner, a humidity of air in a passenger compartment or air on a windshield is controlled in a suitable range so that pleasant performance and defrosting performance can be obtained while fuel consumption ratio of the vehicle engine is improved.

According to the present invention, an air conditioner is mounted on a vehicle having an engine that is operated when at least one of a first engine operation request signal from the air conditioner and a second engine operation request signal from a vehicle condition except for the air conditioner is output, and is stopped when both the first and second engine operation request signals are not output. In the air conditioner, a compressor control means determines a pleasant performance based on a humidity of air in the passenger compartment and determines whether or not operation of the compressor is necessary, and the control unit outputs the first engine operation request signal when the compressor control means determines that the operation of the compressor is necessary. Further, the compressor control means changes a determination level whether or not the compressor operates, so that a stop range of the compressor, when the second engine operation request signal is not output, is made wider than that when the second engine operation request signal is output. Accordingly, even when the second engine operation request signal from the vehicle condition except for the air conditioner is not output, the engine is operated to drive the compressor based on the first engine operation request signal from the air conditioner. Therefore, in this case, air blown into the passenger compartment is conditioned based on the humidity of air in the passenger compartment so that pleasant performance of the passenger compartment is improved. On the other hand, when the first engine operation request signal is not output, the determination level whether or not the compressor operates is changed so that the stop range of the compressor is enlarged in a suitable range where the pleasant performance can be obtained. As a result, the pleasant performance of the passenger compartment can be maintained while the fuel consumption ratio can be improved.

Preferably, the control unit determines a control target temperature of air at a position immediately after the evaporator, by comparing an actual humidity and a control target humidity of air in the passenger compartment. Further, the compressor control means changes the control target temperature or the control target humidity as the determination level to a high temperature side or to a high humidity side, respectively, when the second engine operation request signal is not output, as compared with a case where the second engine operation request signal is output.

Further, control unit divides a range of humidity of air in the passenger compartment into a first humidity area lower than a first predetermined humidity, a second humidity area between the first predetermined humidity and a second predetermined humidity higher than the first predetermined humidity, and a third humidity area higher than the second predetermined humidity. In this case, the control target temperature is changed per each of the first, second and third humidity areas. Preferably, in the first humidity area, the control target temperature is gradually changed to be increased as time passes. In the second humidity area, the control target temperature is changed in accordance with a change tendency of the humidity of air inside the passenger compartment. Further, in the third humidity area, the control target temperature is gradually changed to be decreased as time passes. Accordingly, the pleasant performance of the passenger compartment can be accurately finely controlled, while the fuel economy performance of engine can be further improved.

Preferably, when the vehicle is in a stop state, the output of the second engine operation request signal is stopped. Accordingly, a stop range of the compressor, when the vehicle is in the stop state, can be made wider than that when the vehicle is in a travelling state.

According to the present invention, the control unit includes a compressor control means which determines a fogging state of a windshield based on a humidity of air inside the passenger compartment and determines whether or not operation of the compressor is necessary. When the compressor control means determines that the operation of the compressor is necessary, the control unit outputs the first engine operation request signal. Further, the compressor control means changes a determination level whether or not the compressor operates, so that a stop range of the compressor, when the second engine operation request signal is not output, is made wider than that when the second engine operation request signal is output. Accordingly, the defrosting performance of the windshield can be improved, while the fuel consumption ratio of the engine is improved.

Preferably, the control unit switches a first dehumidifying mode where air is blown toward the windshield while the compressor stops, and a second dehumidifying mode where air is blown toward the windshield while the compressor operates, based on the humidity of air on the windshield. Therefore, when a fogging degree of the windshield is low, it can prevent the windshield from being fogged only using blowing-air while the compressor is stopped. Thus, the stop range of the compressor and the engine can be further made wider, and the fuel economy performance can be further improved. On the other hand, when the fogging degree of the windshield is high, the compressor is operated so that humidified air is blown toward the windshield to accurately prevent the windshield from being fogged.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a schematic diagram of a hybrid vehicle including a vehicle air conditioner, according to a first preferred embodiment of the present invention;

FIG. 2 is a schematic diagram of the vehicle air conditioner according to the first embodiment;

FIG. 3 is a block diagram showing a control system of the vehicle air conditioner according to the first embodiment;

FIG. 4 is a plan view showing a control panel according to the first embodiment;

FIG. 5 is a flow diagram showing a basic control process of an air conditioning ECU of the vehicle air conditioner according to the first embodiment;

FIG. 6 is a characteristic view showing a relationship between a blower voltage and a target air temperature TAO, according to the first embodiment;

FIG. 7 is a characteristic view showing a relationship between an air introduction mode and the target air temperature TAO, according to the first embodiment;

FIG. 8 is a flow diagram of the air conditioning ECU, showing a control of a compressor, according to the first embodiment;

FIG. 9 is a characteristic view showing a relationship between a humidity coefficient f(TR) of a passenger compartment and an inside air temperature TR (room temperature), according to the first embodiment;

FIG. 10 is a characteristic view showing a relationship between a humidity coefficient f(TWS) of a windshield and an estimated temperature TWS of the windshield, according to the first embodiment;

FIG. 11 is a characteristic view showing a relationship between a vehicle speed coefficient KSPD and a vehicle speed SP, according to the first embodiment;

FIG. 12 is a characteristic view showing a relationship between a sunlight correction coefficient KTS and a sunlight amount TS entering into the passenger compartment, according to the first embodiment;

FIG. 13 is a characteristic view showing a relationship between a correction coefficient KRES of an air outlet mode reply and a time, according to the first embodiment;

FIG. 14 is a flow diagram showing a basic control process of an engine ECU according to the first embodiment;

FIG. 15 is a flow diagram of an air conditioning ECU of a vehicle air conditioner, showing a control of a compressor, according to a second preferred embodiment of the present invention;

FIG. 16 is a flow diagram of an air conditioning ECU of a vehicle air conditioner, showing a control of a compressor, according to a third preferred embodiment of the present invention;

FIG. 17 is a flow diagram of an air conditioning ECU of a vehicle air conditioner, showing a control of a compressor, according to a fourth preferred embodiment of the present invention;

FIG. 18 is a flow diagram of an air conditioning ECU of a vehicle air conditioner, showing a control of a compressor, according to a fifth preferred embodiment of the present invention;

FIG. 19 is a flow diagram of an air conditioning ECU of a vehicle air conditioner, showing a control of a compressor, according to a sixth preferred embodiment of the present invention;

FIG. 20 is a flow diagram of an air conditioning ECU of a vehicle air conditioner, showing a control of a compressor, according to a seventh preferred embodiment of the present invention;

FIG. 21 is a flow diagram of an air conditioning ECU of a vehicle air conditioner, showing a control of a compressor, according to an eighth preferred embodiment of the present invention;

FIG. 22 is a flow diagram of an air conditioning ECU of a vehicle air conditioner, showing a part of a compressor control, according to a ninth preferred embodiment of the present invention;

FIG. 23 is a flow diagram of the air conditioning ECU showing the other part of the compressor control, according to the ninth embodiment of the present invention; and

FIG. 24 is a flow diagram of an air conditioning ECU of a vehicle air conditioner, showing a control of a compressor, according to a tenth preferred embodiment of the present invention.

### DETAILED DESCRIPTION OF THE PRESENTLY PREFERRED EMBODIMENTS

Preferred embodiments of the present invention will be described hereinafter with reference to the accompanying drawings.

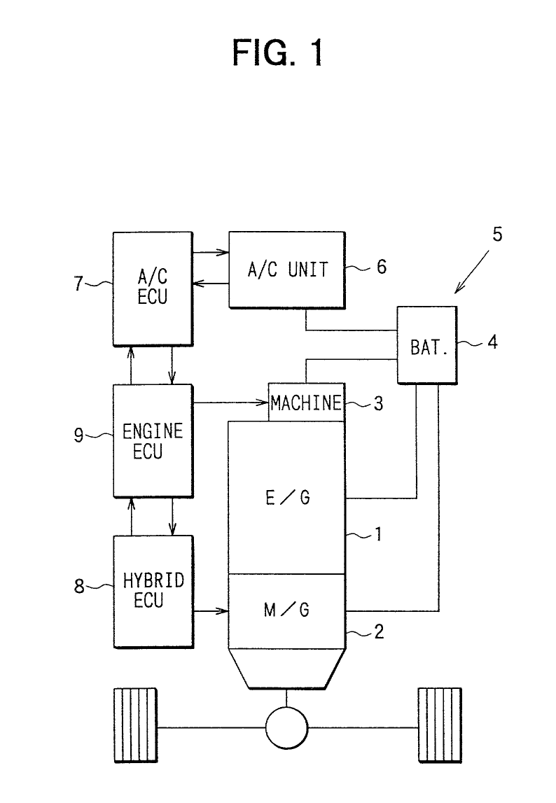

A first preferred embodiment of the present invention will be now described with reference to FIGS. 1-14. In the present invention, the present invention is typically applied to a hybrid vehicle. As shown in FIG. 1, a hybrid vehicle 5 includes an air conditioning unit 6 for performing an air-conditioning operation of a passenger compartment. Each air-conditioning member (e.g., actuator) of the air conditioning unit 6 is controlled by an air-conditioning ECU (A/C ECU), so that temperature or humidity of the passenger compartment can be automatically controlled.

The hybrid vehicle 5 further includes a gasoline engine 1 for travelling, an electrical motor 2 for travelling with an electrical motor function and a generator function, an engine control machine 3, and a battery (e.g., a nickel hydrogen accumulator) for supplying electrical power to the electrical motor 2 or the engine control machine 3. The engine control machine 3 includes a start motor or an ignition unit for starting operation of the engine 1, and a fuel injection unit and the like.

The vehicle engine 1 and the electrical motor 2 are connected detachably to a vehicle shaft of the hybrid vehicle 5 to drive the hybrid vehicle 5. The hybrid vehicle 5 can be travelled selectively only by the power of the engine 1, only by the power of the electrical motor 2 or by both the power of the engine 1 and the power of the electrical motor 2. That is, a case where the hybrid vehicle 5 is traveled only by the power of the vehicle engine 1, a case where the hybrid vehicle 5 is traveled only by the power of the electrical motor 2 and a case where the hybrid vehicle 5 is traveled by both the power of the engine 1 and the power of the electrical motor 2 can be selectively set. The electrical motor 2 is automatically controlled by a hybrid control unit (hereinafter, referred to as “hybrid ECU”) 8. On the other hand, the engine control machine 3 is automatically controlled by an engine control unit (hereinafter, referred to as “engine ECU”) 9. The engine ECU 9 generally electrically controls the engine control machine 3 to supply electrical power to the engine control machine 3 when the hybrid vehicle 5 is a general travelling or when it is necessary to charge the battery 4.

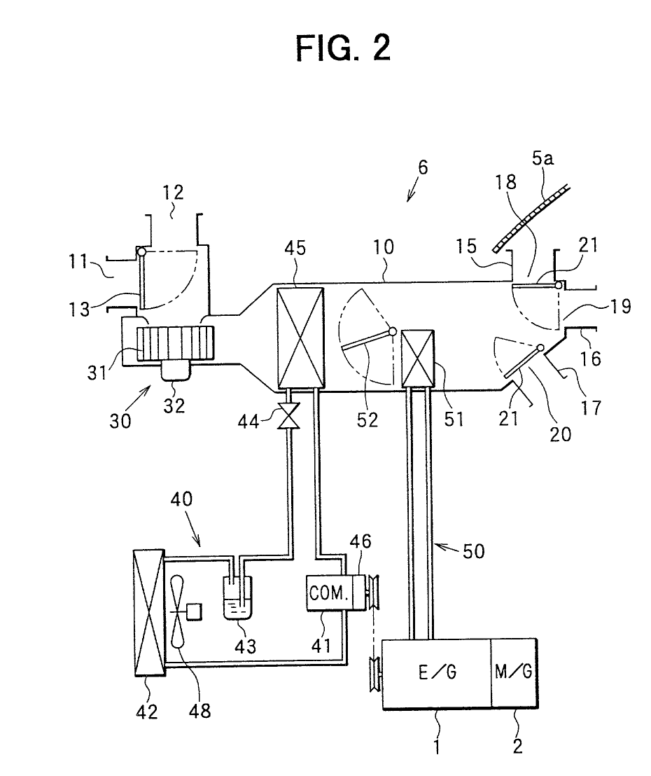

As shown in FIG. 2, the air conditioning unit 6 includes an air conditioning duct 10 forming an air passage through which air is introduced into the passenger compartment of the hybrid vehicle 5, a blower unit 30 for generating an air flow within the air conditioning duct 10, a refrigerant cycle 40 for cooling air flowing through the air conditioning duct 10 to cool the passenger compartment, and a cooling water circuit (hot water circuit) 50 for heating air flowing through the air conditioning duct 10 to heat the passenger compartment.

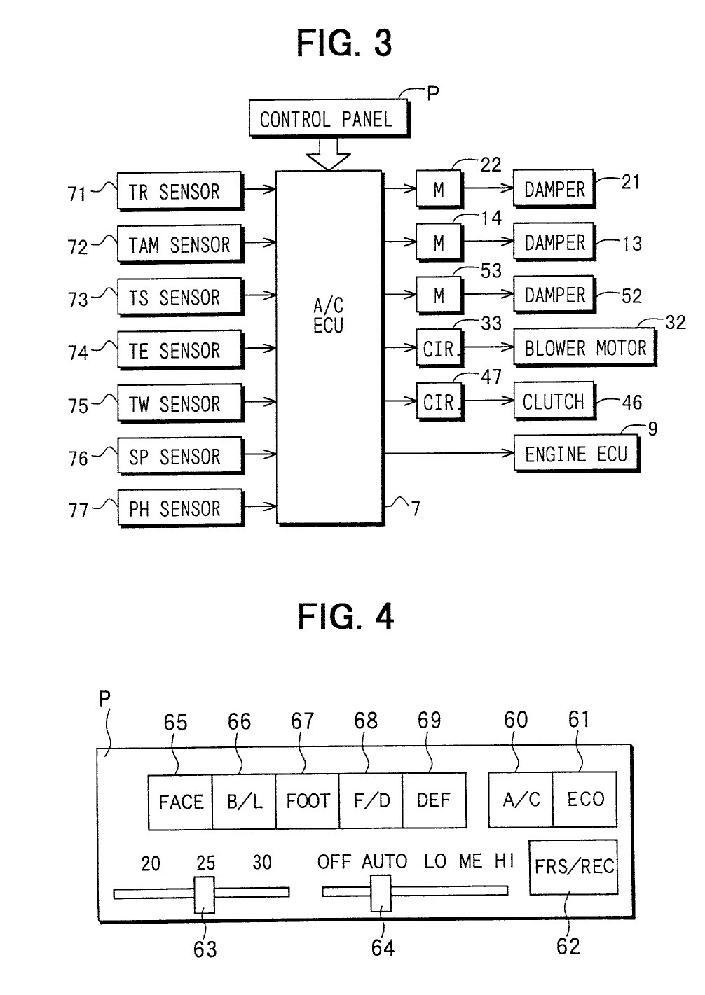

The air conditioning unit 10 is disposed at a front side of the passenger compartment of the hybrid vehicle 5. An inside/outside air switching box for switching inside air or outside air is disposed at a most upstream air side of the air-conditioning duct 10. The inside/outside air switching box has an inside air introduction port 11 for introducing inside air (i.e., air inside the passenger compartment), and an outside air introduction port 12 for introducing outside air (i.e., air outside the passenger compartment). An inside/outside air switching damper 13 is rotatably disposed in the inside/outside air switching box to open and close the inside air introduction port 11 and the outside air introduction port 12. The inside/outside air switching damper 13 is driven by an actuator 14 (see FIG. 3) such as a servomotor so that an air introduction mode such as an inside air introduction mode and an outside air introduction mode can be switched.

An air outlet mode switching portion is provided at a most downstream air side of the air conditioning duct 10. That is, a defroster opening 18, a face opening 19 and a foot opening 20 are provided at the most downstream air side of the air conditioning duct 10. The defroster opening 18 is connected to a defroster duct 15 so that warm air is mainly blown toward an inner surface of a front windshield 5a of the hybrid vehicle 5 from a defroster outlet at a most downstream end of the defroster duct 15.

The face opening 19 is connected to a face duct 16 so that cool air is mainly blown toward the upper side (the head portion) of a passenger in the passenger compartment from a face air outlet at a most downstream end of the face duct 16. Further, the foot opening 20 is connected to a foot duct 17 so that warm air is mainly blown toward the foot area of the passenger in the passenger compartment from a foot air outlet at a most downstream end of the foot duct 17.

Both mode switching dampers 21 are rotatably disposed in the air conditioning duct 10 to open and close the openings 18-20. Both the mode switching dampers 21 are respectively driven by an actuator 22 (see FIG. 3) such as a servomotor to selectively switch a face mode, a bi-level mode, a foot mode, a foot/defroster mode or a defroster mode.

The blower 30 includes a centrifugal fan 31 rotatably disposed in a scroll case integrated with the air conditioning duct 10, and a blower motor 32 for driving and rotating the centrifugal fan 31. The blower motor 32 controls a rotation speed of the centrifugal fan 31 based on a blower voltage applied to the blower motor 32 through a blower driving circuit 33 (see FIG. 3).

The refrigerant cycle 40 includes a compressor 41 which is driven by the engine 1 and compresses refrigerant, a condenser 42 for condensing the compressed refrigerant, a receiver (gas-liquid separator) 43 for separating condensed refrigerant into gas refrigerant and liquid refrigerant, an expansion valve (decompressing means) 44 for decompressing liquid refrigerant from the receiver 43, and an evaporator 45 for evaporating refrigerant decompressed in the expansion valve 44, and refrigerant pipes connecting those refrigerant members.

The evaporator 45 is an interior heat exchanger cooling and dehumidifying air flowing through the air conditioning duct 10. An electromagnetic clutch 46 is connected to the compressor 41 to interrupt a transmission of a rotation power from the engine 1 to the compressor 41. An electrical power supply of the electromagnetic clutch 46 is controlled by a clutch driving circuit 47 (see FIG. 3). The electrical power supplied to the electromagnetic clutch 46 is on/off controlled by the clutch driving circuit 47 so that the operation of the compressor 41 is controlled.

In the cooling water circuit 50, cooling water warmed in a water jacket of the engine 1 circulates by a water pump. In the cooling water circuit 50, a radiator, a servomotor and a heater core 51 are provided. Cooling water for cooling the engine 1 flows into the heater core 51 so that air from the evaporator 45 is heated by the heater core 51 in the air conditioning duct 10.

The heater core 51 is disposed in the air conditioning duct 10 at a downstream air side of the evaporator 45. An air mixing damper 52 is disposed in the air conditioning duct 10 at an upstream air side of the heater core 51. The air mixing damper 52 is driven by an actuator 53 (see FIG. 3) such as a servomotor so that a rotation position of the air mixing damper 52 is adjusted. By the rotation position of the air mixing damper 52, an air amount passing through the heater core 51 and an air amount bypassing the heater core 51 is adjusted so that the temperature of air blown into the passenger compartment is adjusted.

Next, a control system according to the first embodiment will be now described based on FIGS. 1, 3 and 4. Into the air conditioning ECU 7, communication signals output from the engine ECU 9, switch signals from operation switches of a control panel P provided on a front surface within the passenger compartment and sensor signals from various sensors are input.

Specifically, as shown in FIG. 4, the switches provided on the control panel P are an air conditioning (A/C) switch 60, an economy (ECO) switch 61, an air-introduction mode selecting switch 62 for switching an air introduction mode, a temperature setting lever 63 for setting the temperature of the passenger compartment at a desired temperature, an air amount setting lever 64 for setting an air amount blown from the centrifugal fan 31, and an air outlet mode setting switches 65-69 for selectively setting an air outlet mode.

The air conditioning switch 60 is an air conditioning operation switch for setting a cooling mode based on mainly the pleasant performance within the passenger compartment. In the cooling mode, a cooling degree of the evaporator 45 is adjusted at a low temperature side. On the other hand, the economy switch 61 is an air conditioning operation switch for setting an economy mode based on mainly the fuel economy performance. In the economy mode, the cooling degree of the evaporator 45 is set at a high-temperature side so that operation power of the compressor 45 is reduced.

When the air amount setting lever 64 is operated at the Off position, electrical power supplied to the blower motor 32 is stopped. When the air amount setting lever 64 is operated at the AUTO position, the blower voltage applied to the blower motor 32 is automatically controlled. When the air amount setting lever 64 is operated at the LO position, the blower voltage applied to the blower motor 32 is set at a minimum value. When the air amount setting lever 64 is operated at the ME position, the blower voltage applied to the blower motor 32 is set at a middle value. Further, when the air amount setting lever 64 is operated at the HI position, the blower voltage applied to the blower motor 32 is set at a maximum value.

The air outlet mode setting switches include a face switch 65 for setting a face mode, a bi-level mode switch 66 for setting a bi-level mode, a foot switch 67 for setting a foot mode, a foot/defroster switch 68 for setting a foot/defroster mode, and a defroster switch 69 for setting a defroster mode.

As shown in FIG. 3, plural sensors 71-77 are provided so that sensor signals are input into the air/conditioning ECU 7. That is, an inside air temperature sensor 71 is disposed to detect temperature (TR) of inside air inside the passenger compartment, an outside air temperature sensor 72 is disposed to detect temperature (TAM) of outside air outside the passenger compartment, a sunlight amount sensor 73 is disposed to detect a sunlight amount (TS) entering into the passenger compartment, a post-evaporator temperature sensor 74 is disposed to detect temperature (TE) of air immediately after passing through the evaporator 45, a water temperature sensor 75 is disposed to detect temperature (TW) of engine-cooling water flowing into the heater core 51, a vehicle speed sensor 76 is disposed to detect a vehicle speed (SP) of the hybrid vehicle 5, and a humidity sensor 77 is disposed to detect a relative humidity (RH) of air in the passenger compartment of the hybrid vehicle 5.

The post-evaporator temperature sensor 74 is disposed at a position immediately after the evaporator 45 to detect the temperature (TE) of air immediately after passing through the evaporator 45. On the other hand, the humidity sensor 77 is disposed at a lower side of the instrument panel to detect a voltage corresponding to the relative humidity (RH) of air within the passenger compartment.

Within the air conditioning ECU 7, a micro-computer constructed by CPU, ROM, RAM and the like is provided. Signals from the sensors 71-77 are input into the microcomputer of the air-conditioning ECU 7 after being A/D converted. When an ignition switch of the hybrid vehicle 5 is turned on, electrical power is supplied from the battery 4 to the air conditioning ECU 7.

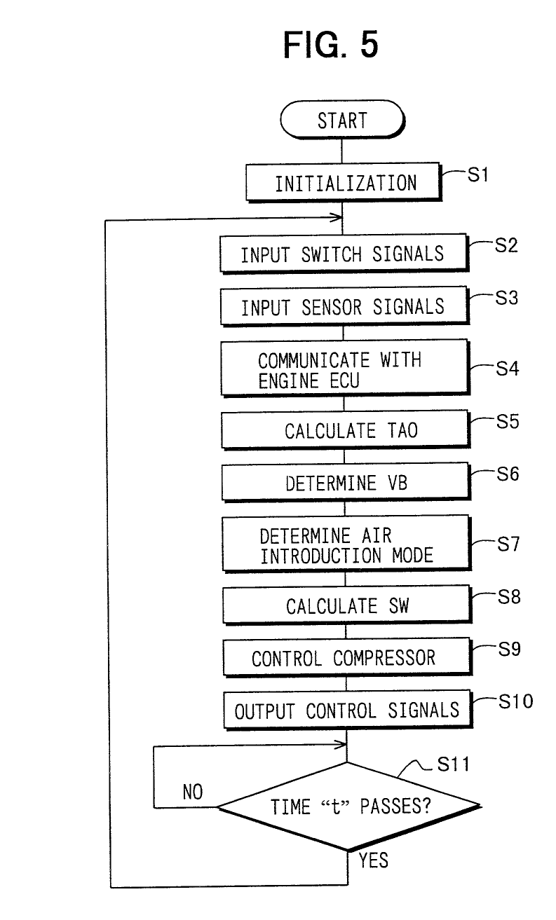

Next, control operation of the air conditioning ECU 7 will be now described with reference to FIGS. 5-7. FIG. 5 shows a base control program due to the air conditioning ECU 7. As shown in FIG. 5, when the ignition switch is turned on and electrical power is supplied to the air conditioning ECU 7, the control routine of FIG. 5 is started. Firstly, an initialization is performed at step S1. Next, switch signals from each switch such as the temperature setting lever 63 are input at step S2. Next, at step S3, sensor signals from the sensors 71-77 are input after being A/D converted.

Next, at step S4, a communication with the engine ECU 9 is performed. That is, a first engine operation request signal (first E/G ON signal) or a first engine stop request signal (first E/G OFF signal), determined based on a condition whether or not it is necessary to operate the engine 1 in the air conditioner, is output from the air conditioning ECU 7 to the engine ECU 9. On the other hand, a second engine operation request signal or a second engine stop request signal, determined based on a condition except for the air conditioner, is input to the air conditioning ECU 7 from the engine ECU 9.

Next, a target air temperature TAO blown into the passenger compartment is calculated based on the following formula (1) stored beforehand in the ROM.

TAO=KSET×TSET−KR×TR−KAM×TAM−KS×TS+C (1)

wherein, TSET is a set temperature set by the temperature setting lever 63, TR is the inside air temperature detected by the inside air temperature sensor 71, TAM is the outside air temperature detected by the outside air temperature sensor 72, TS is the sunlight amount detected by the sunlight amount sensor 73. Further, KSET, KR, KAM and KS are coefficients, and C is a correction constant.

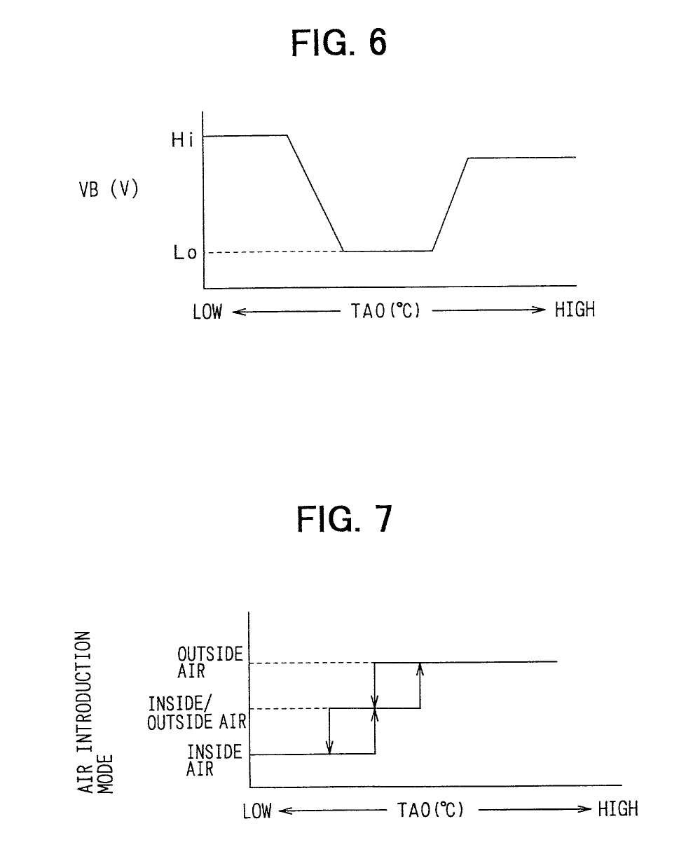

Next, at step S6, a blower voltage VB applied to the blower motor 32 is determined based on the target air temperature TAO calculated at step S5 in accordance with the characteristic graph of FIG. 6 beforehand stored in the ROM.

Next, at step S7, the air introduction mode is determined based on the target air temperature TAO in accordance with the characteristic view of FIG. 7 beforehand stored in the ROM. That is, as shown in FIG. 7, when the target air temperature TAO is changed from a low temperature to a high temperature, the air introduction mode is changed from an inside air introduction mode to an outside air introduction mode after passing through an inside/outside air introduction mode (half mode). In the first embodiment, as shown in FIG. 4, an air outlet mode is set by manually operating the switches 65-69 provided in the control panel P. However, the air outlet mode can be automatically set based on the target air temperature TAO.

Next, at step S8, a target opening degree SW of the air mixing damper 52 is calculated by using the following formula (2) beforehand stored in the ROM, based on the target air temperature TAO calculated at step S5, the water temperature TW of the engine-cooling water and the post-evaporator temperature TE of air immediately after the evaporator 45.

SW=[(TAO−TE)/(TW−TE)]×100(%) (2)

The water temperature TW of the engine-cooling water is input from the water temperature sensor 75, and the poet-evaporator temperature TE of air immediately after the evaporator 45 is input from the post-evaporator temperature sensor 74.

When SW≦0%, the air mixing damper 52 is controlled at a maximum cooling position so that all cool air from the evaporator 45 bypasses the heater core 51. When SW≧0%, the air mixing damper 52 is controlled at a maximum heating position so that all cool air from the evaporator 45 passes through the heater core 51. Further, when 0(%)<SW<100(%), the air mixing damper 52 is controlled at a position between the maximum cooling position and the maximum heating position so that a part of cool air from the evaporator 45 passes through the heater core 51 and the other part of thereof bypasses the heater core 51.

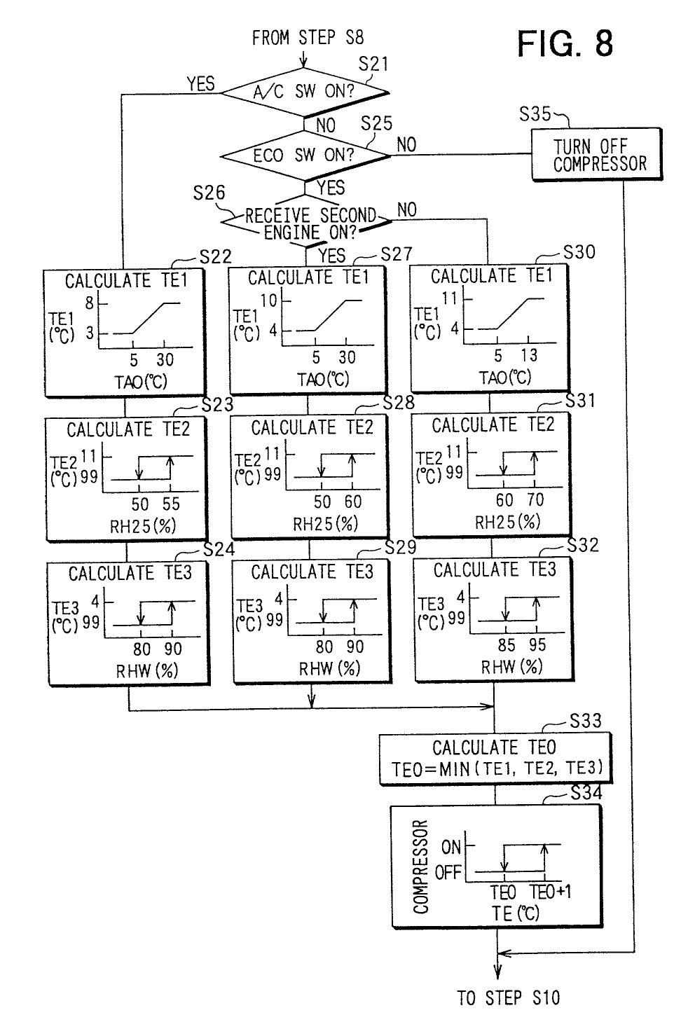

Next, at step S9, a control state of the compressor 41 is determined when the air conditioning switch 60 is turned on or when the economy switch 61 is turned. The detain control of the compressor 41 is described later based on the control routine in FIG. 8.

Next, at step S10, control signals are output to the actuators 14, 22, 53, the blower driving circuit 33 and the clutch driving circuit 47 so that control states of step S5-S9 are obtained. Thereafter, at step S11, it is determined whether or not a predetermined time “t” (e.g., 0.5−2.5 seconds) passes. After the predetermined time passes, the control routine returns at step S2.

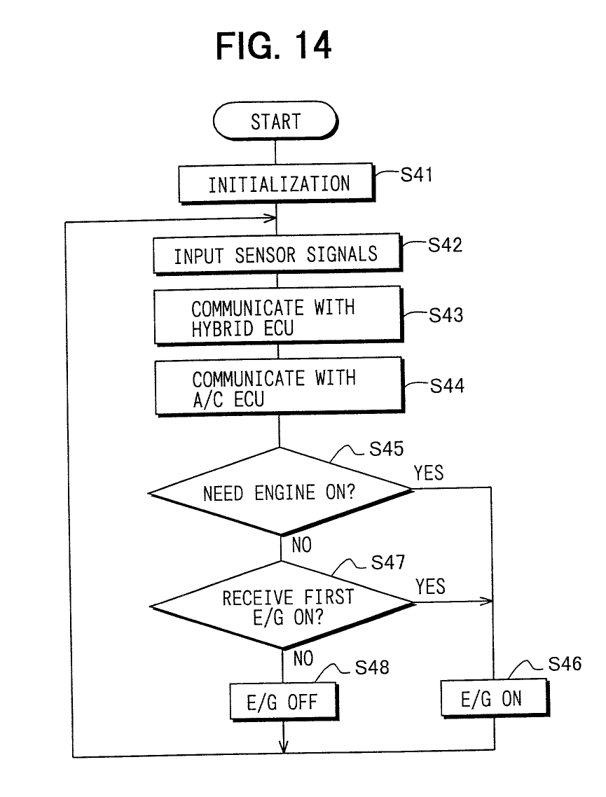

Next, the control of the engine ECU 9 will be described based on FIG. 14. Sensor signals from sensors for detecting operation states of the hybrid vehicle 5 and communication signals from the air conditioning ECU 7 and the hybrid ECU 8 are input into the engine ECU 9. The sensors for detecting operation states of the hybrid vehicle 5 include an engine rotation speed sensor, a throttle opening degree sensor, a battery voltage sensor, a cooling water temperature sensor for detecting temperature of cooling water in the engine 1, the vehicle speed sensor 76 and the like. Within the engine ECU 9, a micro-computer constructed by CPU, ROM, RAM and the like is provided. Signals from the sensors are input into the micro-computer of the engine ECU 9 after being A/D converted.

When the ignition switch of the hybrid vehicle 5 is turned on and electrical power is supplied to the engine ECU 9, the control routine of FIG. 14 starts. First, at step S41, an initialization and an initial setting are performed. Next, at step S42, sensor signals from the engine rotation speed sensor, the vehicle speed sensor 76 the throttle opening degree sensor, the battery voltage sensor and the cooling water temperature sensor and the like are input. Next, at step S43, a communication with the hybrid ECU 8 is performed. Further, at step S44, a communication with the air conditioning ECU 7 is performed.

Next, at step S45, engine operation state is determined based on the sensor signals. That is, on/off state of the engine is determined. Specifically, when the vehicle speed of the hybrid vehicle 5 detected by the vehicle speed sensor 76 is equal to or larger than 40 km/h, or when the voltage of the battery 4 detected by the battery voltage sensor is smaller than a predetermined voltage in which it is necessary to charge the battery 4, it is determined that the operation of the engine 1 is required. In this case, it is determined that the operation of the engine 1 is necessary to be turned on. When it is determined that the operation of engine is necessary at step S45, a control signal is output to the engine control machine 3 so that the operation of the engine 1 is started (ON) at step S46. Thereafter, control program returns to step S42.

When it is determined that the operation state (ON state) of the engine is not necessary, that is, when an engine stop is required at step S45, it is determined whether or not the first engine operation request signal (first E/G ON signal) is received from the air conditioning ECU 7 at step S47. The first engine operation request signal (first E/G ON signal) or the first engine stop request signal (first E/G OFF signal) is input at step S44. When the first engine stop request signal (first E/G OFF signal) is determined at step S47, it is determined that the first engine stop request signal (first E/G OFF signal) is received from the air conditioning ECU 7, and a control signal for stopping the engine 1 is output to the engine control machine 3 at step S48. Thereafter, the control program returns to step S48. On the other hand, when first engine operation request signal (first E/G ON signal) is determined at step S47, it is determined that the first engine operation request signal (first E/G ON signal) is received from the air conditioning ECU 7, and a control signal for starting the engine 1 is output to the engine control machine 3 at step S46.

Next, the control of the compressor 41 at step S9 of FIG. 5 will be described in detail based on the control program of FIG. 8. Here, there are performed regarding a temperature control for controlling temperature of air blown into the passenger compartment to the set temperature, a humidity control for controlling the humidity of air in the passenger compartment in a suitable range, and a defrosting control for defrosting the front windshield 5a. Therefore, a target post-evaporator air temperature TE1 necessary for performing a temperature control, a target post-evaporator air temperature TE2 necessary for performing a humidity control, and a target post-evaporator air temperature TE3 necessary for performing a defrosting control are calculated, respectively. Among those post-evaporator air temperatures TE1, TE2, TE3, the smallest target post-evaporator air temperature is determined as a final target post-evaporator air temperature TEO, and compressor 41 is controlled based on the final target post-evaporator air temperature TEO.

Further, the target post-evaporator temperature is controlled at a high temperature side when an engine operation request from a condition except for the air conditioner is not output, as compared with a case where an engine operation request from a condition except for the air conditioner is output. Accordingly, in the first embodiment, a range of stop condition of the compressor 41 and the engine 1 can be made wider, so that fuel consumption of the engine 1 can be reduced.

That is, as shown in FIG. 8, at step S21, it is determined whether or not the air conditioning switch 60 is turned on. When the air conditioning switch 60 is turned on at step S21, the first target post-evaporator air temperature TE1 for the temperature control is calculated based on the target air temperature TAO in accordance with the characteristic view of step S22 stored in the ROM, at step S22. Specifically, the first target post-evaporator air temperature TE1 is set at 3° C. when the target air temperature TAO is lower than 5° C., the first target post-evaporator air temperature TE1 is set at 8° C. when the target air temperature TAO is higher than 30° C., and the first target post-evaporator air temperature TE1 is set in a range 3° C.-8° C. when the target air temperature TAO is in a range of 5° C.-30° C. In this case, when a temperature difference (TAO-TIN) between the target air temperature TAO and an air introduction temperature TIN is equal to or larger than 5° C., the first target poet-evaporator air temperature TE1 is set at an abnormal high temperature (e.g., TE1=99° C.), so that the operation of the compressor 41 is stopped.

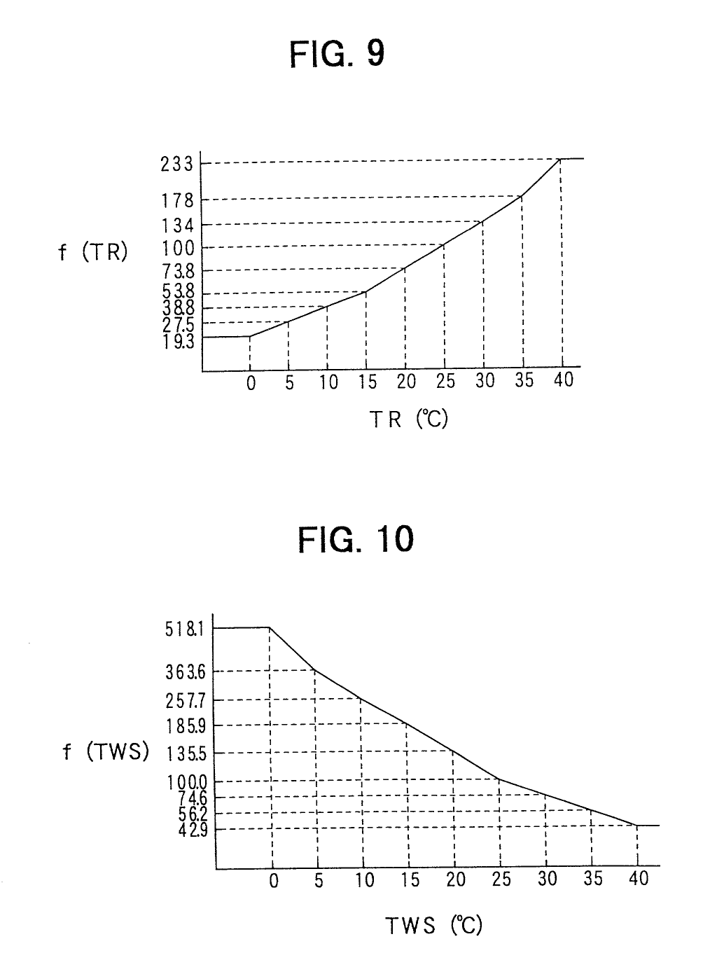

Next, at step S23, the second target post-evaporator air temperature TE2 for the humidity control is calculated based on a relative humidity RH25 corresponding to the air of 25° C. in accordance with the characteristic view of step S23 stored in the ROM. The relative humidity RH25 corresponding to the air of 25° C. is calculated based on the relative humidity RH detected by the humidity sensor 77 and a humidity coefficient f(TR) of the passenger compartment calculated from the characteristic view of FIG. 9, in accordance with the following formula (3) stored beforehand in the ROM.

RH25=f(TR)×RH/100(%) (3)

As shown in the characteristic view of step S23, the second target post-evaporator air temperature TE2 is set at 99° C. when the relative humidity RH25 of the passenger compartment is equal to or smaller than 50%, and the second target poet-evaporator air temperature TE2 is set at 11° C. when the relative humidity RH25 of the passenger compartment is equal to or larger than 55%.

Next, at step S24, the third target post-evaporator air temperature TE3 for the defrosting control is calculated based on a relative humidity RHW of air on the front windshield 5a in accordance with the characteristic view of step S24 stored in the ROM.

At step S24, first, an estimated temperature TWS of the windshield 5a is calculated based on the following formula (4) stored beforehand in the ROM.

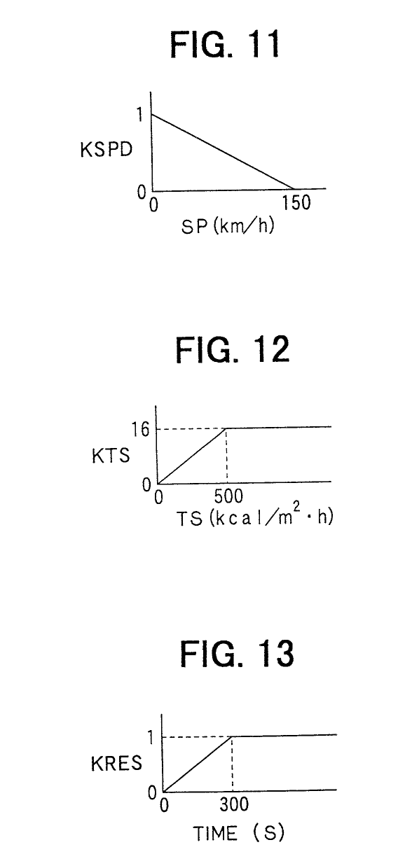

TWS TAM+KSPD×{KTS+(TR−TAM)/25+KRES(TAO−TAM)/50}−C1 (4)

wherein, KSPD is a vehicle speed coefficient calculated based on the characteristic view shown in FIG. 11, KTS is a sunlight correction coefficient calculated based on the characteristic view shown in FIG. 12, KRES is a correction coefficient of an air outlet mode reply calculated based on the characteristic view shown in FIG. 13, and C1 is a correction constant. The time shown in FIG. 13 is a passed time after air-blowing toward the front windshield 5a is started. In the formula (4), the estimated temperature TWS of the windshield 5a is calculated based on the outside air temperature TAM while the influences of the vehicle speed and the sunlight amount are considered. However, the estimated temperature TWS of the windshield 5a can be calculated based on the outside air temperature TAM while an influence of the air blowing amount, the cooling water temperature TW or the air introduction mode is considered.

At step S24, next, a humidity coefficient f(TWS) of a glass surface of the windshield is calculated based on the estimated temperature TWS and the characteristic view shown in FIG. 10 stored on the ROM. Further, the relative humidity RHW of the windshield is calculated based on the following formula (5) stored beforehand in the ROM.

RHW=f(TWS)×RH25/100(%) (5)

Next, the third target post-evaporator temperature TE3 is calculated based on the relative humidity RHW of the windshield and the characteristic view of step S24.

As shown in the characteristic view of step S24, the third target post-evaporator air temperature TE3 is set at 99° C. when the relative humidity RHW of the glass surface of the windshield is equal to or smaller than 80%, and the third target post-evaporator air temperature TE3 is set at 4° C. when the relative humidity RHW of the glass surface of the windshield is equal to or larger than 90%.

As described above, through steps S22-S24, the first, second and third target post-evaporator temperatures TE1, TE2, TE3 can be calculated.

Next, at step S33, the smallest value among the target post-evaporator temperatures TE1, TE2, TE3 calculated at steps S22-S24 is determined as the finial target post-evaporator air temperature TEO. Next, at step S34, the on/off state (operation state) of the compressor 41 is determined based on the characteristic view of step S34 stored beforehand in the ROM. That is, when the post-evaporator air temperature TE is equal to or lower than the final target post-evaporator temperature TEO, an off signal is output to the electromagnetic clutch 46, so that the operation of the compressor 41 is stopped, and the output of the first engine operation request signal (first E/G ON signal) is made off. When the post-evaporator air temperature TE is equal to or larger than the (TEO+1), an on signal is output to the electromagnetic clutch 46, so that the compressor 41 is started, and the first engine operation request signal (first E/G ON signal) is output.

On the other hand, when the air conditioning switch 60 is turned off at step S21, it is determined whether or not the economy switch 61 is turned on at step S25. When the economy switch 61 is turned on at step S25, it is determined whether or not the second engine operation request signal (second E/G ON signal) except for the air conditioner is received. The determination of the second engine operation request signal (second E/G ON signal) except for the air conditioner at step S26 is performed based on signals input from the engine ECU 9 to the air conditioning ECU 7.

When it is determined that the second engine operation request signal (second E/G ON signal) except for the air conditioner is received at step S26, the first target poet-evaporator air temperature TE1 for the temperature control is calculated based on the target air temperature TAO in accordance with the characteristic view of step S27 stored in the ROM, at step S27. Specifically, the first target poet-evaporator air temperature TE1 is set at 4° C. when the target air temperature TAO is lower than 5° C., the first target poet-evaporator air temperature TE1 is set at 10° C. when the target air temperature TAO is higher than 30° C., and the first target post-evaporator air temperature TE1 is set in a range 4° C.-10° C. when the target air temperature TAO is in a range of 5° C.-30° C. In this case, when a temperature difference (TAO-TIN) between the target air temperature TAO and the air introduction temperature TIN is equal to or larger than 5° C., the first target post-evaporator air temperature TE1 is set at an abnormal high temperature (e.g., TE1=99° C.), so that the operation of the compressor 41 is stopped.

Next, at step S28, the second target post-evaporator air temperature TE2 for the humidity control is calculated based on the relative humidity RH25 corresponding to the air of 25° C. in accordance with the characteristic view of step S28 stored in the ROM. As shown in the characteristic view of step S28, the second target post-evaporator air temperature TE2 is set at 99° C. when the relative humidity RH25 of the passenger compartment is equal to or smaller than 50%, and the second target post-evaporator air temperature TE2 is set at 11° C. when the relative humidity RH25 of the passenger compartment is equal to or larger than 60%.

Next, at step S29, the third target post-evaporator air temperature TE3 for the defrosting control is calculated based on the relative humidity RHW of air on the front windshield 5a in accordance with the characteristic view of step S29 stored in the ROM. As shown in the characteristic view of step S29, the third target post-evaporator air temperature TE3 is set at 99° C. when the relative humidity RHW of the glass surface of the windshield is equal to or smaller than 80%, and the third target post-evaporator air temperature TE3 is set at 4° C. when the relative humidity RHW of the glass surface of the windshield is equal to or larger than 90%.

As described above, through steps S27-S29, the first, second and third target post-evaporator temperatures TE1, TE2, TE3 can be calculated.

Next, at step S33, the smallest value among the target post-evaporator temperatures TE1, TE2, TE3 calculated at steps S27-S29 is determined as the finial target post-evaporator air temperature TEO. Next, at step S34, the on/off state (operation state) of the compressor 41 is determined based on the characteristic view of step S34 stored beforehand in the ROM.

On the other hand, when the second engine operation request signal (second E/G ON signal) except for the air conditioner is not received at step S26, control program moves step S30. At step S30, the first target post-evaporator air temperature TE1 for the temperature control is calculated based on the target air temperature TAO in accordance with the characteristic view of step S30 stored in the ROM. Specifically, the first target post-evaporator air temperature TE1 is set at 4° C. when the target air temperature TAO is lower than 5° C., the first target post-evaporator air temperature TE1 is set at 11° C. when the target air temperature TAO is higher than 13° C., and the first target post-evaporator air temperature TE1 is set in a range 4° C.-11° C. when the target air temperature TAO is in a range of 5° C.-13° C. In this case, when a temperature difference (TAO-TIN) between the target air temperature TAO and the air introduction temperature TIN is equal to or larger than 5° C., the first target post-evaporator air temperature TE1 is set at an abnormal high temperature (e.g., TE1=99° C.), so that the operation of the compressor 41 is stopped.

Next, at step S31, the second target post-evaporator air temperature TE2 for the humidity control is calculated based on the relative humidity RH25 corresponding to the air of 25° C. in accordance with the characteristic view of step S31 stored in the ROM. As shown in the characteristic view of step S31, the second target post-evaporator air temperature TE2 is set at 99° C. when the relative humidity RH25 of the passenger compartment is equal to or smaller than 60%, and the second target post-evaporator air temperature TE2 is set at 11° C. when the relative humidity RH25 of the passenger compartment is equal to or larger than 70%.

Next, at step S32, the third target post-evaporator air temperature TE3 for the defrosting control is calculated based on the relative humidity RHW of air on the front windshield 5a in accordance with the characteristic view of step S32 stored in the ROM. As shown in the characteristic view of step S32, the third target post-evaporator air temperature TE3 is set at 99° C. when the relative humidity RHW of the glass surface of the windshield is equal to or smaller than 85%, and the third target post-evaporator air temperature TE3 is set at 4° C. when the relative humidity RHW of the glass surface of the windshield is equal to or larger than 95%.

As described above, through steps S30-S32, the first, second and third target post-evaporator temperatures TE1, TE2, TE3 can be calculated.

Next, at step S33, the smallest value among the target post-evaporator temperatures TE1, TE2, TE3 calculated at steps S30-S32 is determined as the finial target post-evaporator air temperature TEO. Next, at step S34, the on/off state (operation) of the compressor 41 is determined based on the characteristic view of step S34 stored beforehand in the ROM.

On the other hand, when it is determined that the air conditioning switch 60 and the economy switch 61 are turned off at steps S21 and S25, the compressor 41 is turned off at step S35. Further, at step S35, the output of the first engine operation request signal (first E/G ON signal) is made off.

In the first embodiment, when step S22 is compared with step S27, the first target post-evaporator air temperature at step S27 is made higher than that at step S22 at the same target air temperature TAO. Further, when step S28 is compared with step S23, the switch of the second target post-evaporator temperature TE2 at step S28 is performed at a high humidity side than that at step S23. Thus, the stop range of the compressor 41 and the engine 1 when the economy switch 61 is turned on is wider than that when the air conditioning switch 60 is turned on. That is, in the present invention, when the air conditioning switch 60 is turn on, the pleasant performance of the passenger compartment is mainly considered. On the other hand, when the economy switch 61 is turned on, the fuel economy performance of the engine 1 is mainly considered.

On the other hand, when step S27 is compared with step S30, the first target post-evaporator air temperature TE1 at step S30 is made higher than that at step S27 at the same target air temperature TAO. Further, when step S31 is compared with step S28, the switch of the second target poet-evaporator temperature TE2 at step S31 is performed at a high humidity side than that at step S28. In addition, when step S32 is compared with step S29, the switch of the third target post-evaporator temperature TE3 at step S32 is performed at a high humidity side than that at step S29. Thus, the stop range of the compressor 41 and the engine 1, when the economy switch 61 is turned on and the second engine operation request signal (second E/G ON signal) except for the air conditioner is not received, is wider than that when the economy switch 61 is turned on and the second engine operation request signal (second E/G ON signal) except for the air conditioner is received. That is, when the economy switch 61 is turned on and when the second engine operation request signal (second E/G ON signal) except for the air conditioner is not received, the fuel economy performance is more mainly considered. Even when the economy switch 61 is turned on and the second engine operation request signal (second E/G ON signal) except for the air conditioner is not received, because the relative humidity RH25 of the passenger compartment is controlled to be equal to or lower than 70%, unpleasant feeling of the passenger can be prevented. Further, in this case, because the relative humidity RHW of the windshield 5a is controlled to be equal to or lower than 95%, it can prevent the windshield 5a from being fogged.

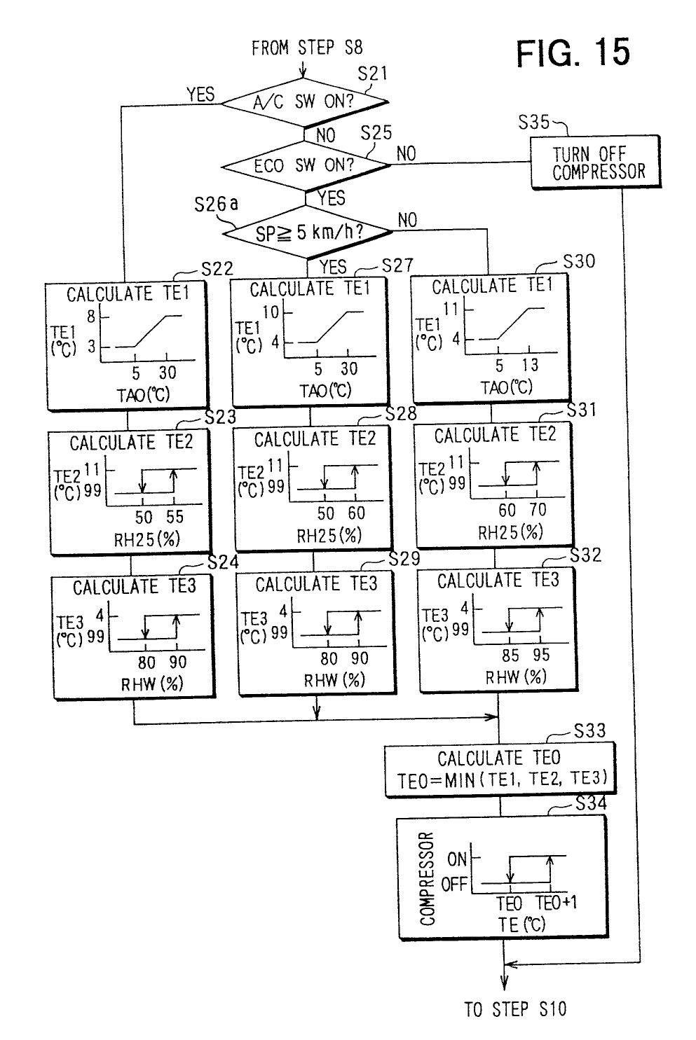

A second preferred embodiment of the present invention will be now described with reference to FIG. 15. In the second embodiment, the control at step S26 in FIG. 8 of the first embodiment is changed to that of step S26a in FIG. 15, and the other parts are similar to those of the first embodiment. That is, at step S26a, it is determined whether or not the vehicle speed (SP) of the hybrid vehicle 5 is equal to or larger than 5 km/h. When it is determined that the vehicle speed (SP) of the hybrid vehicle 5 is equal to or larger than 5 km/h, the control of step S27 is performed. On the other hand, when the vehicle speed (SP) of the hybrid vehicle 5 is smaller than 5 km/h, it is determined that the hybrid vehicle 5 is actually in a stop state, and the control of step S30 is performed.

When the economy switch 61 is turned on, the stop range of the compressor 41 and the engine 1 in the stop state of the hybrid vehicle 5 is wider than that in the traveling state of the hybrid vehicle 5.

Generally, when the vehicle speed (SP) is equal to or smaller than 40 km/h and when it is unnecessary to charge the battery 4, the second engine operation request signal (second E/G ON signal) is not output. Because the frequency in charging the battery 4 is low, the second engine operation request signal (second E/G ON signal) is generally not output in the stop state of the hybrid vehicle 5. Accordingly, even when the control of step S27 and the control of step S30 are switched based on the travelling state or the stop state of the hybrid vehicle 5, the effect about similar to that of the first embodiment can be obtained.

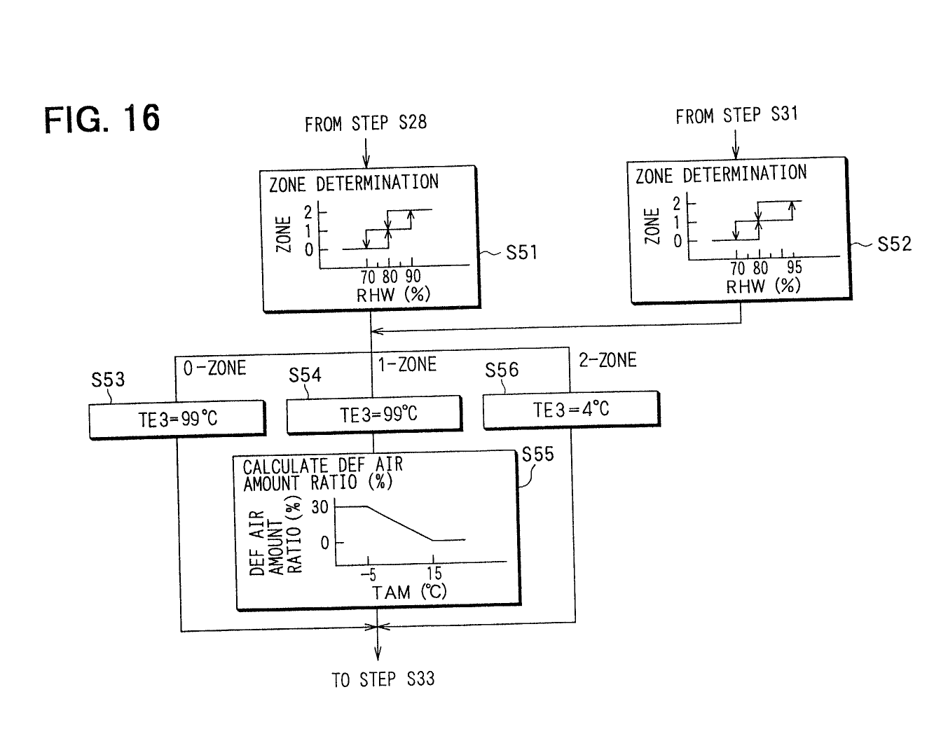

A third preferred embodiment of the present invention will be now described with reference to FIG. 16. In the third embodiment, the control at steps S29 and S32 in FIG. 8 of the first embodiment is changed to that of steps S51 and S52 in FIG. 16, respectively, and the other parts are similar to those of the first embodiment.

That is, in the third embodiment, when the second engine operation request signal (second E/G ON signal) is received at step S26 in FIG. 8, the control at step S51 is performed after the controls at steps S27 and S28 are performed. That is, at step S51, 0-zone of a low humidity area, 1-zone of a middle humidity area and 2-zone of a high humidity area are set, and a zone determination is performed based on the relative humidity of the windshield 5a in accordance with the characteristic view of step S51 pre-stored in the ROM. When the relative humidity RHW of the windshield 5a is increased to be larger than 80%, the zone state is changed from 0-zone to 1-zone. Further, when the relative humidity RHW of the windshield 5a is increased to be larger than 90%, the zone state is changed from 1-zone to 2-zone. On the other hand, when the relative humidity RHW of the windshield 5a is decreased to 80%, the zone state is changed from 2-zone to 1-zone. Further, when the relative humidity RHW of the windshield 5a is decreased to 70%, the zone state is changed from 1-zone to 0-zone.

On the other hand, when the second engine operation request signal (second E/G ON signal) is not received at step S26 in FIG. 8, the control at step S52 is performed after the controls at steps S30 and S31 are performed. That is, at step S52, 0-zone of a low humidity area, 1-zone of a middle humidity area and 2-zone of a high humidity area are set, and the zone determination is performed based on the relative humidity RHW of the windshield in accordance with the characteristic view of step S52 pre-stored in the ROM. At step S52, when the relative humidity RHW of the windshield is increased to be larger than 95%, the zone state is changed from 1-zone to 2-zone.

When the 0-zone is determined at step S51 or step S52, the third post-evaporator air temperature TE3 is set at 99° C. at step S53, and the final post-evaporator air temperature TEO is calculated at step S33. Because it is unnecessary to perform a dehumidifying operation for the defrosting in the 0-zone of the low-humidity area, the third post-evaporator air temperature TE3 is set at 99° C., and the operation of the compressor 41 is stopped.

When the 1-zone is determined at step S51 or step S52, the third post-evaporator air temperature TE3 is set at 99° C. at step S53, and an air amount ratio blown from the defroster opening 18 is calculated based on the outside air temperature TAM in accordance with the characteristic view of step S55 pre-stored. Specifically, when the outside air temperature TAM is high in the summer or a middle season, the windshield 5a is difficult to be frosted, and an unpleasant feeling is given to a passenger when warm air is blown from the defroster opening 18. Therefore, when the outside air temperature TAM is higher than 15° C., the air amount ratio blown from the defroster opening 18 is set at 0%. On the other hand, when outside air temperature TAM is low, the windshield 5a is readily fogged, an air amount ratio from the defroster opening 18 is increased. When the outside air temperature TAM is changed from 15° C. to −5° C., the air amount ratio from the defroster opening 18 is gradually increased from 0% to 30%, and the foot/defroster mode is set as the air outlet mode. The air amount ratio from the defroster opening 18 is adjusted by the both mode switching dampers 21 (see FIG. 2).

Next, at step S33, the final post-evaporator air temperature TEO is calculated. In the 1-zone of the middle humidity area, the third post-evaporator air temperature TE3 is set at 99° C. at step S54 so that the compressor 41 is stopped, while air is blown toward the windshield 5a to defrost the windshield 5a when the outside air temperature TAM 10 is low.

On the other hand, when the 2-zone is determined at step S51 or step S52, the third post-evaporator air temperature TE3 is set at 4° C. at step S56, and the final target post-evaporator air temperature TEO is set at step S33. In the 2-zone of the high humidity area, the third poet-evaporator air temperature TE3 is set at 4° C. so that the compressor 41 is controlled to be operated, and it can accurately prevent the fogging of the windshield by the dehumidified air.

According to the third embodiment of the present invention, in the middle humidity area, because the compressor 41 is stopped and it can prevent the windshield 5a from being fogged only using air blown toward the windshield 5a, the stop area of the compressor 41 and the engine 1 can be made wider, and the fuel economy performance can be improved. Further, when the second engine operation request signal (second E/G ON signal) except for the air conditioner is not received, the range of the middle humidity area is enlarged to a high humidity side, and the stop range of the compressor 41 and the engine 1 can be made further wider, as compared with a case where the second engine operation request signal (second E/G ON signal) except for the air conditioner is received. Accordingly, in this case, the fuel economy performance can be further improved.

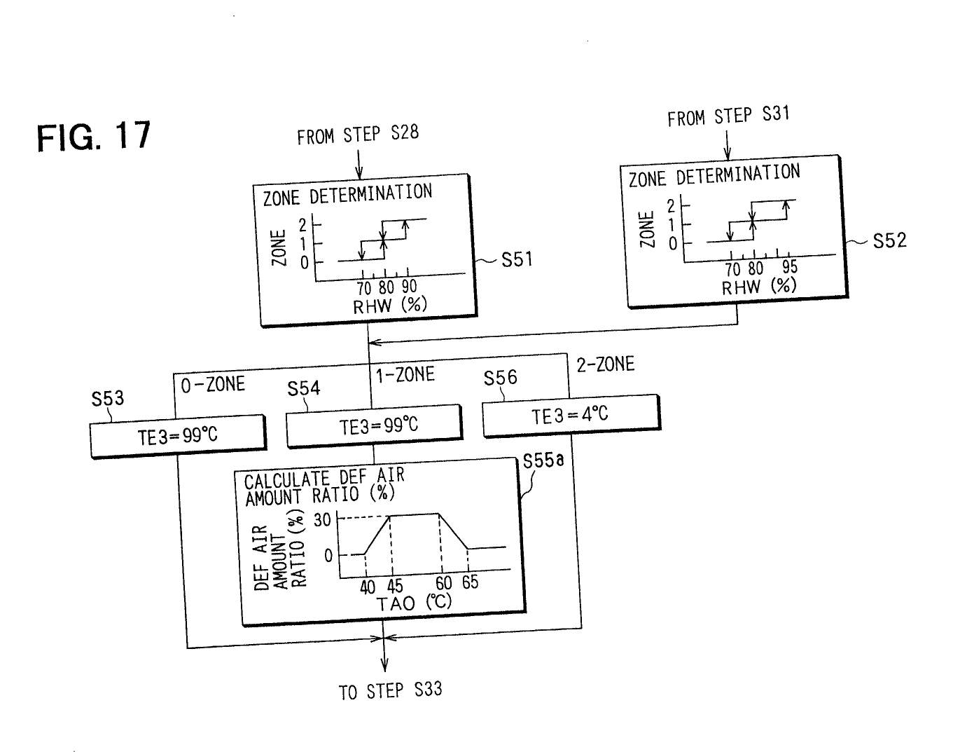

A fourth preferred embodiment of the present invention will be now described with reference to FIG. 17. In the 0 fourth embodiment, the control of step S55 in the third embodiment is changed to the control of step S55a. In the fourth embodiment, the other parts are similar to those of the above-described third embodiment.

At step S55a, the air amount ratio blown from the defroster opening 18 (see FIG. 2) is calculated based on the target air temperature TAO in accordance with the characteristic view of step S55a. Specifically, because the defrosting effect is low when the target air temperature TAO is low, the air amount ratio blown from the defroster opening 18 is set at 0% when the target air temperature TAO is lower than 40° C. On the other hand, because an unpleasant feeling is given to the passenger in the passenger compartment when the target air temperature TAO is high, the air amount ratio blown from the defroster opening 18 is set at 0% when the target air temperature TAO is higher than 60° C. Further, when the target air temperature TAO is in a range of 45-60° C., the air amount ratio blown from the defroster opening 18 is set at 30%. When the target air temperature TAO is in a range of 40-45° C. or in a range of 60-65° C., the air amount ratio blown from the defroster opening 18 is set to be in a range of 0-30%.

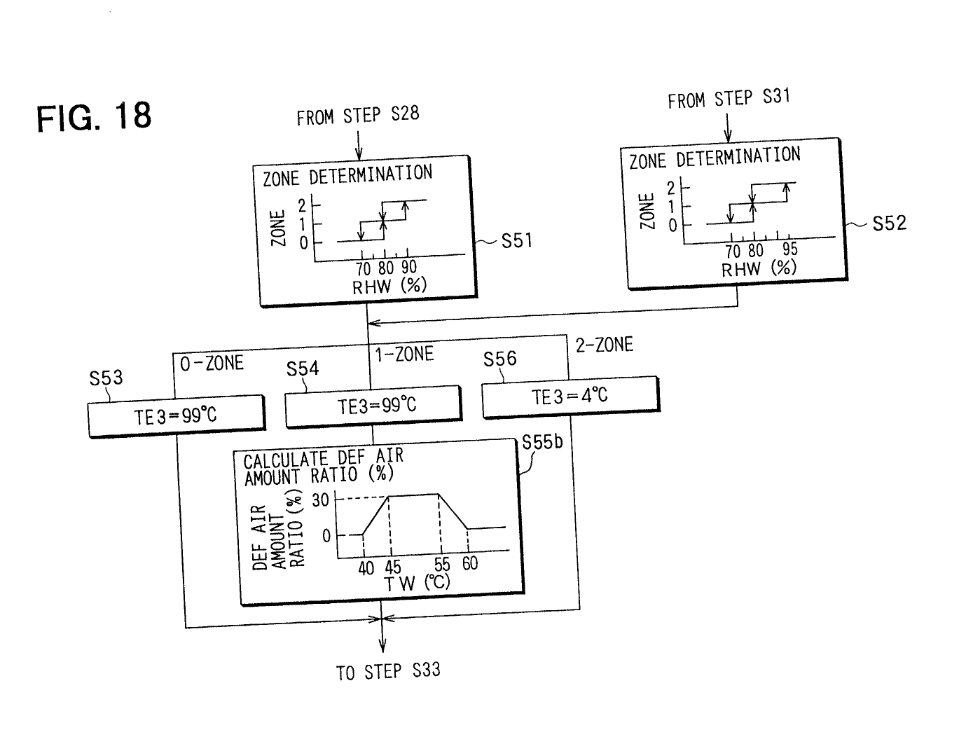

A fifth preferred embodiment of the present invention will be now described with reference to FIG. 18. In the fifth embodiment, the control of step S55 in the third embodiment is changed to the control of step S55b in FIG. 18. In the fifth embodiment, the other parts are similar to those of the above-described third embodiment.

At step S55b, the air amount ratio blown from the defroster opening 18 (see FIG. 2) is calculated based on the cooling water temperature TW in accordance with the characteristic view of step S55b. Specifically, because the defrosting effect becomes lower when the cooling water temperature TW becomes lower, the air amount ratio blown from the defroster opening 18 is set at 0% when the cooling water temperature TW is lower than 40° C. On the other hand, because an unpleasant feeling is given to the passenger in the passenger compartment when the cooling water temperature TW is high, the air amount ratio blown from the defroster opening 18 is set at 0% when the cooling water temperature TW is higher than 60° C. Further, when the cooling water temperature TW is in a range of 45-55° C., the air amount ratio blown from the defroster opening 18 is set at 30%. When the cooling water temperature TW is in a range of 40-45° C. or in a range of 55-60° C., the air amount ratio blown from the defroster opening 18 is set to be in a range of 0-30%.

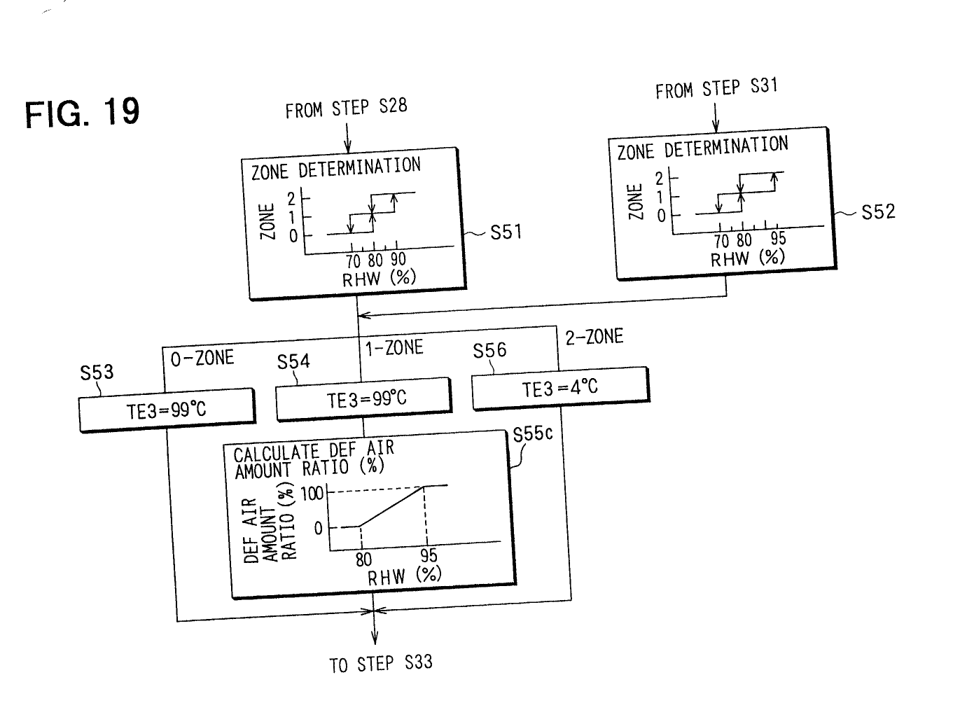

A sixth preferred embodiment of the present invention will be now described with reference to FIG. 19. In the sixth embodiment, the control of step S55 in the third embodiment is changed to the control of step S55c in FIG. 19. In the sixth embodiment, the other parts are similar to those of the above-described third embodiment.

At step S55c, the air amount ratio blown from the defroster opening 18 (see FIG. 2) is calculated based on the relative humidity RHW of the windshield in accordance with the characteristic view of step S55c. Specifically, because the windshield 5a is difficult to be fogged when the relative humidity RHW of the windshield 5a becomes lower, the air amount ratio blown from the defroster opening 18 is set at 0% when the relative humidity RHW of the windshield 5a is lower than 80%. On the other hand, when the relative humidity RHW of the windshield 5a is changed from 80% to 95%, the air amount ratio blown from the defroster opening 18 is gradually increased from 0% to 100%.

According to the sixth embodiment, the air amount ratio blown from the defroster opening 18 is controlled based on the relative humidity RHW which is mainly related to the fogging degree of the windshield 5a, and the air amount ratio from the defroster opening 18 is increased when the windshield 5a is readily fogged. Therefore, defrosting effect of the windshield 5a can be effectively improved.

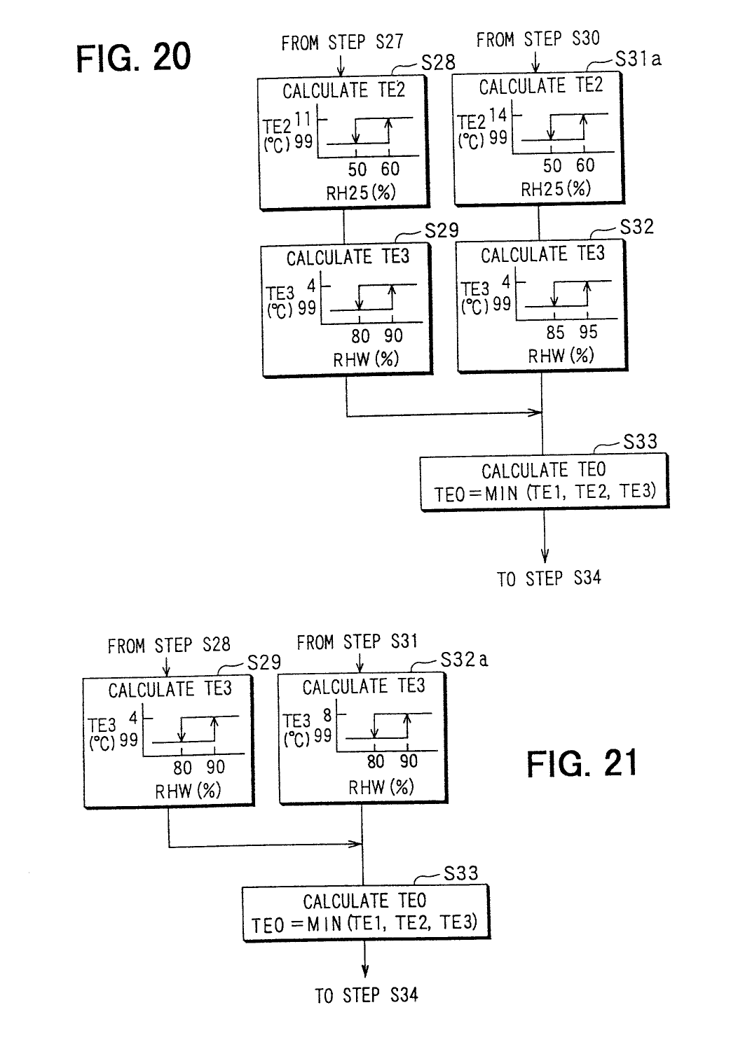

A seventh preferred embodiment of the present invention will be now described with reference to FIG. 20. In the seventh embodiment, the control of step S31 in the first embodiment or the second embodiment is changed to the control of step S31a in FIG. 20. In the seventh embodiment, the other parts are similar to those of the above-described first or second embodiment.

Specifically, at step S31a, the set values of the relative humidity RH25 of the passenger compartment, for switching the second target post-evaporator temperature TE2, are set to be similar to those at step S28. That is, as shown in the characteristic view of step S31a in FIG. 20, the second target post-evaporator air temperature TE2 is set at 99° C. when the relative humidity RH25 of the passenger compartment is equal to or smaller than 50%, and the second target poet-evaporator air temperature TE2 is set at 14° C. when the relative humidity RH25 of the passenger compartment is equal to or larger than 60%.

Even when the second target post-evaporator temperature TE2 is made higher in the high humidity area at step S31a, when the second engine operation request signal (second E/G ON signal) except for the air conditioner is not received or the hybrid vehicle 5 is in the stop state, the stop range of the compressor 41 and the engine 1 can be made wider, and the fuel economy performance can be improved.

However, the set values of the relative humidity RH25 of the passenger compartment, for switching the second target post-evaporator temperature TE2, can be set at higher values (e.g., 55%-65%) that is higher than those at step S28. In this case, when the second engine operation request signal (second E/G ON signal) except for the air conditioner is not received or the hybrid vehicle 5 is in the stop state, the stop range of the compressor 41 and the engine 1 can be made further wider, and the fuel economy performance can be further improved.

An eighth preferred embodiment of the present invention will be now described with reference to FIG. 21. In the eighth embodiment, the control of step S32 in the first embodiment or the second embodiment is changed to the control of step S32a. In the eighth embodiment, the other parts are similar to those of the above-described first or second embodiment.

Specifically, at step S32a, the set values of the relative humidity RHW of the windshield 5a, for switching the third target post-evaporator temperature TE3, are set to be similar to those at step S29. That is, as shown in the characteristic view of step S32a, the third target poet-evaporator air temperature TE3 is set at 99° C. when the relative humidity RHW of the windshield 5a is equal to or smaller than 80, and the third target post-evaporator air temperature TE3 is set at 8° C. when the relative humidity RHW of the windshield 5a is equal to or larger than 90%.

Even when the third target post-evaporator temperature TE3 is made higher in the high humidity area at step S32a, when the second engine operation request signal (second E/G ON signal) except for the air conditioner is not received or the hybrid vehicle 5 is in the stop state, the stop range of the compressor 41 and the engine 1 can be made wider, and the fuel economy performance can be improved.

However, the set values of the relative humidity RHW of the windshield 5a, for switching the third target poet-evaporator temperature TE3, can be set at higher values (e.g., 85%-95%) that is higher than those at step S29. In this case, when the second engine operation request signal (second E/G ON signal) except for the air conditioner is not received or the hybrid vehicle 5 is in the stop state, the stop range of the compressor 41 and the engine 1 can be made further wider, and the fuel economy performance can be further improved.

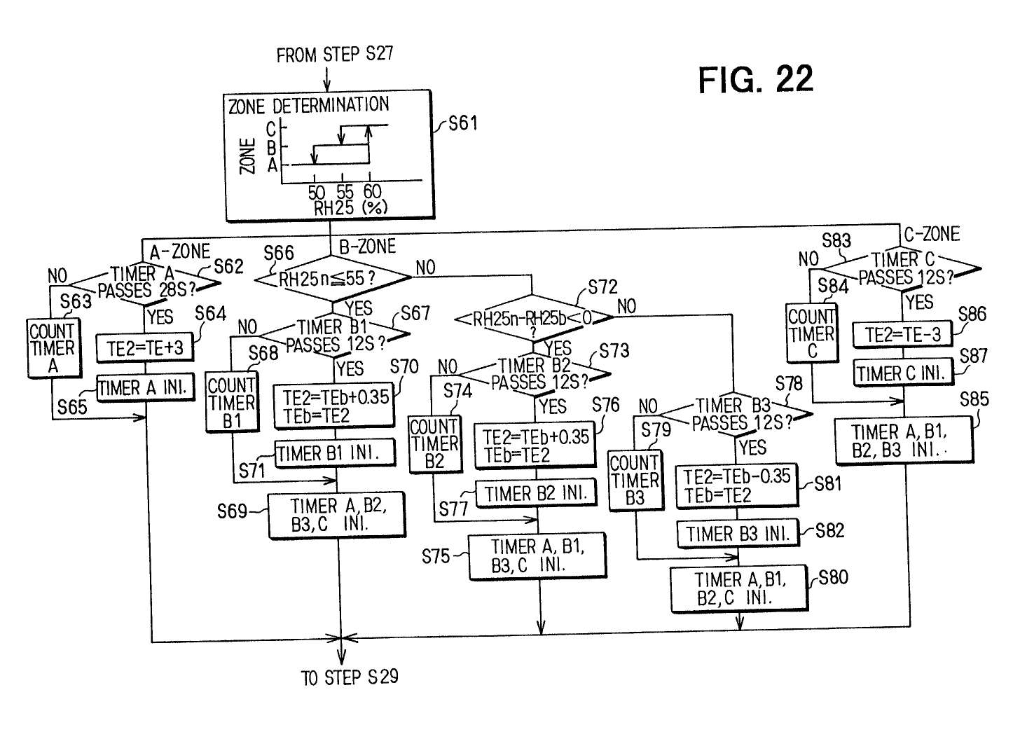

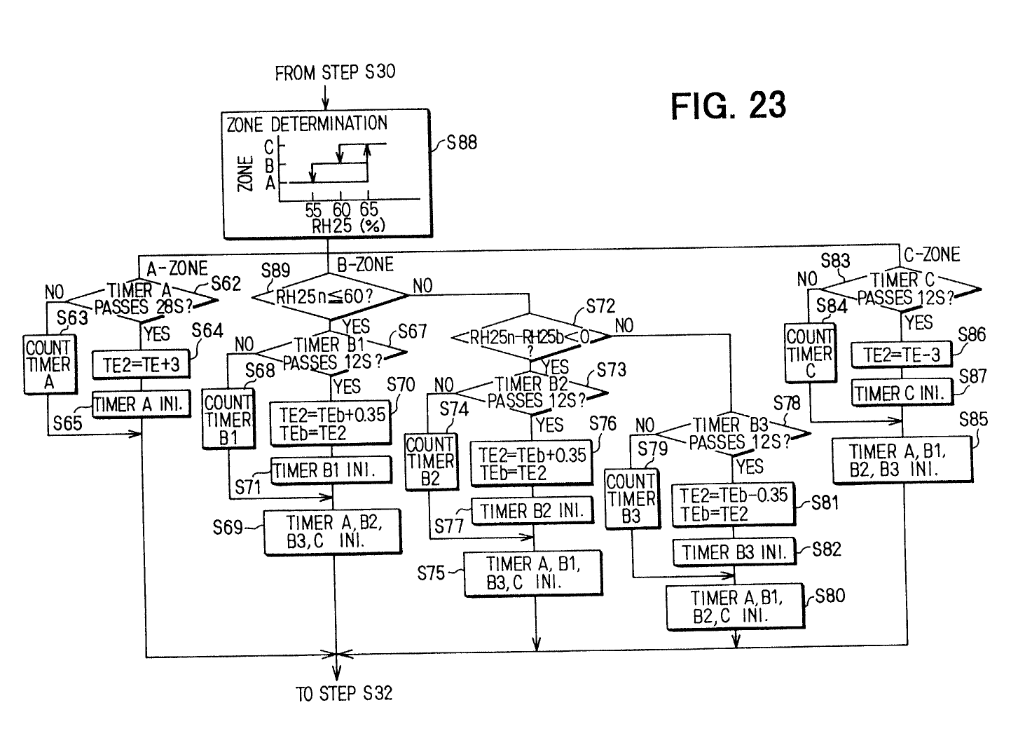

A ninth preferred embodiment of the present invention will be now described with reference to FIGS. 22 and 23. In the ninth embodiment, the controls of step S28 and step S31 in the first embodiment or the second embodiment are changed. In the ninth embodiment, the other parts are similar to those of the above-described first or second embodiment. In the ninth embodiment, the second target post-evaporator temperature TE2 is finely changed in accordance with the relative humidity RH25 of the passenger compartment so that pleasant performance of the passenger compartment is improved, while the stop range of the compressor 41 and the engine 1 is enlarged so that the fuel economy performance is further improved.

Next, the control of the ninth embodiment will be described in detail based on FIGS. 22 and 23. When the second engine operation request signal (second E/G ON signal) except for the air conditioner is output or the hybrid vehicle 5 is in the travelling state, the control of step S61 is performed through step S27, as shown in FIG. 22. At step S61, A-zone of a low humidity area, B-zone of a middle humidity area and C-zone of a high humidity area are set, and a zone determination is performed based on the relative humidity RH25 of the passenger compartment in accordance with the characteristic view of step S61 pre-stored in the ROM. When the relative humidity RH25 of the passenger compartment is increased to be larger than 60%, the zone state is changed from A-zone or B-zone to C-zone. Further, when the relative humidity RH25 of the passenger compartment is decreased to 55%, the zone state is changed from C-zone to B-zone. Further, when the relative humidity RH25 of the passenger compartment is decreased to 50%, the zone state is changed from B-zone to A-zone.

When the A-zone is determined at step S61, it is determined whether or not a measured time of a timer A passes a predetermined time (e.g., 28 seconds) at step S62. Here, the measured time of the timer A is a passing time after the second target post-evaporator temperature TE2 is set at step 64. When it is determined that the measured time of the timer A does not pass the predetermined time (e.g., 28 seconds) at step S62, the count of the timer A is continuously performed at step S63, and thereafter the control of step S29 is performed. On the other hand, when it is determined that the measured time of the timer A passes the predetermined time (e.g., 28 seconds), the second target post-evaporator temperature TE2 is set at a value higher than the present post-evaporator air temperature TE by 3° C. (i.e., TE2=TE+3° C.) at step S64. Next, after the initialization of the timer A is performed at step S65, the control at step S29 is performed.

That is, in the A-zone of the low humidity area, the second target post-evaporator air temperature TE2 is made higher when the timer A passes the predetermined time (e.g., 28 seconds), so that stop range of the compressor 41 and the engine 1 can be made wider. Further, when the humidity of the passenger compartment is rapidly changed, an unpleasant feeling may be given to the passenger. However, in the ninth embodiment, because the second target post-evaporator air temperature TE2 is gradually changed (e.g., changes per 28 seconds), the unpleasant feeling due to a rapid humidity change can be prevented.

On the other hand, when the B-zone is determined at step S61, it is determined whether or not the present relative humidity RH25n of the passenger compartment is equal to or smaller than 55% at step S66. When the present relative humidity RH25n of the passenger compartment is equal to or smaller than 55% at step S66, it is determined whether or not a measured time of a timer B1 passes a predetermined time (e.g., 12 seconds) at step S67. Here, the measured time of the timer B1 is a passing time after the second target poet-evaporator temperature TE2 is set at step 70. When it is determined that the measured time of the timer B does not pass the predetermined time (e.g., 12 seconds) at step S67, the count of the timer B1 is continuously performed at step S68, and thereafter the control of step S69 is performed. That is, at step S69, the initialization of the other timers except for the timer B1 are performed. On the other hand, when it is determined that the measured time of the timer B1 passes the predetermined time (e.g., 12 seconds) at step S67, the second target post-evaporator temperature TE2 is set at a value higher than a second target post-evaporator air temperature TEb before 12 seconds by 0.35° C. (i.e., TE2=TEb+0.35° C.) at step S70. Further, at step S70, the presently set second target post evaporator air temperature TE2 is stored as the second target post-evaporator air temperature TEb before 12 seconds, for the next time. Next, after the initialization of the timer B1 is performed at step S71, the control at step S69 is performed.

As described above, in a relatively low humidity area among the B-zone, the second target post-evaporator air temperature TE2 is made higher so that the stop range of the compressor 41 and the engine 1 is enlarged, while the pleasant performance of the passenger compartment is improved.

Next, when the present relative humidity RH25n of the passenger compartment is larger than 55% at step S66, it is determined whether or not the relative humidity of the passenger compartment is decreased at step S72 by comparing the present relative humidity RH25n of the passenger compartment and a relative humidity RH25b before 4 seconds. When it is determined that the relative humidity of the passenger compartment is decreased at step S72, it is determined whether or not a measured time of a timer B2 passes a predetermined time (e.g., 12 seconds) at step S73. Here, the measured time of the timer B2 is a passing time after the second target post-evaporator temperature TE2 is set at step 76. When it is determined that the measured time of the timer B2 does not pass the predetermined time (e.g., 12 seconds) at step S73, the count of the timer B2 is continuously performed at step S74, and thereafter, the control of step S75 is performed. That is, at step S75, the initialization of the other timers except for the timer B2 are performed. On the other hand, when it is determined that the measured time of the timer B2 passes the predetermined time (e.g., 12 seconds) at step S73, the second target post-evaporator temperature TE2 is set at a value higher than a second target post-evaporator air temperature TEb before 12 seconds by 0.35° C. (i.e., TE2=TEb+0.35° C.) at step S76. Further, at step S76, the presently set second target post-evaporator air temperature TE2 is stored as the second target post-evaporator air temperature TEb before 12 seconds, for the next time. Next, after the initialization of the timer B2 is performed at step S77, the control at step S75 is performed.

As described above, even in a relatively high humidity area among the B-zone, the second target post-evaporator air temperature TE2 is made higher when the humidity of the passenger compartment is decreased. Accordingly, the stop range of the compressor 41 and the engine 1 can be enlarged, while the pleasant performance of the passenger compartment is improved.

Next, when it is determined that the relative humidity of the passenger compartment is increased at step S72, it is determined whether or not a measured time of a timer B3 passes a predetermined time (e.g., 12 seconds) at step S78. Here, the measured time of the timer B3 is a passing time after the second target post-evaporator temperature TE2 is set at step 81. When it is determined that the measured time of the timer B3 does not pass the predetermined time (e.g., 12 seconds) at step S78, the count of the timer B3 is continuously performed at step S79, and thereafter, the control of step S80 is performed. That is, at step S80, the initialization of the other timers except for the timer B3 are performed. On the other hand, when it is determined that the measured time of the timer B3 passes the predetermined time (e.g., 12 seconds) at step S78, the second target post-evaporator temperature TE2 is set at a value lower than a second target post-evaporator air temperature TEb before 12 seconds by 0.35° C. (i.e., TE2=TEb−0.35° C.) at step S81. Further, at step S81, the presently set second target post-evaporator air temperature TE2 is stored as the second target post-evaporator air temperature TEb before 12 seconds, for the next time. Next, after the initialization of the timer B3 is performed at step S82, the control at step S80 is performed.

As described above, in a relatively high humidity area among the B-zone, the second target post-evaporator air temperature TE2 is made lower when the humidity of the passenger compartment is increased. Accordingly, the compressor 41 is operated so that the defrosting operation of the windshield 5a is performed. Therefore, the pleasant performance of the passenger compartment can be maintained.

When the C-zone is determined at step S61, it is determined whether or not a measured time of a timer C passes a predetermined time (e.g., 12 seconds) at step S83. Here, the measured time of the timer C is a passing time after the second target post-evaporator temperature TE2 is set at step S86. When it is determined that the measured time of the timer C does not pass the predetermined time (e.g., 12 seconds) at step S83, the count of the timer C is continuously performed at step S84, and thereafter, the control of step S85 is performed. That is, at step S85, the initialization of the other timers except for the timer C are performed. On the other hand, when it is determined that the measured time of the timer C passes the predetermined time (e.g., 12 seconds) at step S83, the second target post-evaporator temperature TE2 is set at a value lower than the present post-evaporator air temperature TE by 3° C. (i.e., TE2=TE−3° C.) at step S86. Next, after the initialization of the timer C is performed at step S87, the control at step S85 is performed.

As described above, in the C-zone of the high humidity area, the second target post-evaporator air temperature TE2 is made lower. Accordingly, the compressor 41 is controlled to be operated so that the defrosting operation of the windshield 5a is performed. Therefore, the pleasant performance of the passenger compartment can be maintained in the C-zone.

When the second engine operation request signal (second E/G ON signal) except for the air conditioner is not output or the hybrid vehicle 5 is in the stop state, the control of step S88 is performed through step S30, as shown in FIG. 23. In FIG. 23, step S61 and step S66 of FIG. 22 are changed to step S88 and step S89, respectively. In FIG. 23, the other steps are similar to those of FIG. 22. Specifically, the relative humidity RH25 of the passenger compartment at step S88 is set higher than that at step S61 in FIG. 22 by 5%. Accordingly, the determination level of the present relative humidity RH15n at step S89 is set higher than the determination level at step S66 in FIG. 22 by 5%.

Thus, when the second engine operation request signal (second E/G ON signal) except for the air conditioner is not output or when the hybrid vehicle 5 is in the stop state, the stop range of the compressor 41 and the engine 1 can be further enlarged, and the fuel economy performance can be further improved.

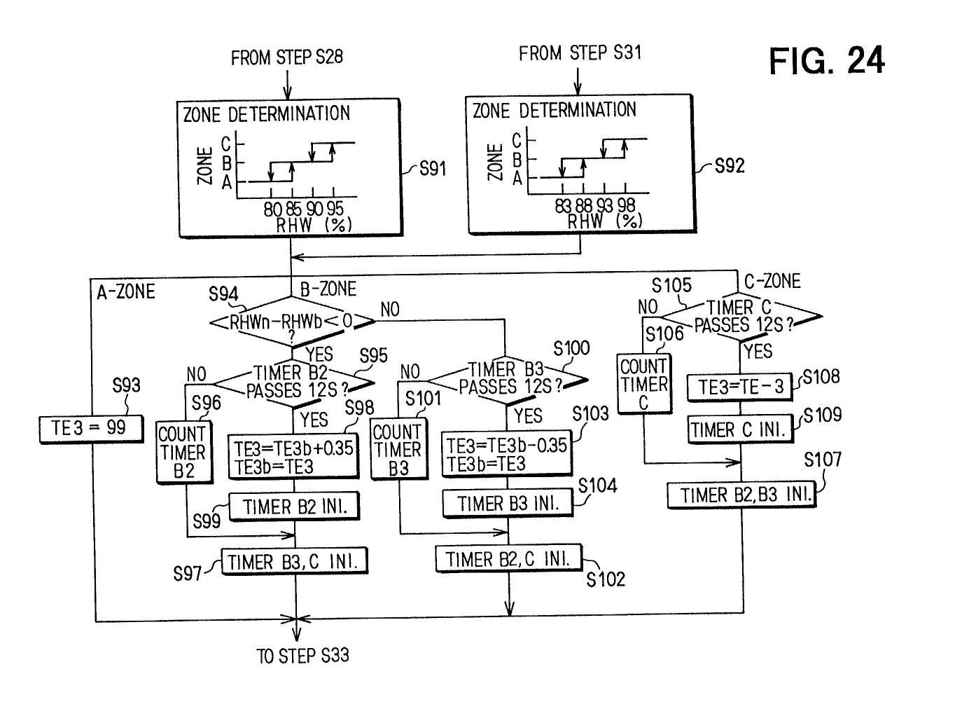

A tenth preferred embodiment of the present invention will be now described with reference to FIG. 24. In the tenth embodiment, the controls of step S29 and step S32 in the first embodiment or the second embodiment are changed. In the tenth embodiment, the other parts are similar to those of the above-described first or second embodiment. In the ninth embodiment, the third target post-evaporator temperature TE3 is finely changed in accordance with the relative humidity RHW of the windshield 5a so that defrosting performance of the windshield 5a is improved, while the stop range of the compressor 41 and the engine 1 is enlarged so that the fuel economy performance is further improved.

Next, the control of the tenth embodiment will be described in detail based on FIG. 24. When the second engine operation request signal (second E/G ON signal) except for the air conditioner is output or the hybrid vehicle 5 is in the travelling state, the control of step S91 is performed through step S28, as shown in FIG. 24. At step S91, A-zone of a low humidity area, B-zone of a middle humidity area and C-zone of a high humidity area are set, and a zone determination is performed based on the relative humidity RHW of the windshield in accordance with the characteristic view of step S91 pre-stored in the ROM. When the relative humidity RHW is increased to be larger than 85%, the zone state is changed from A-zone to B-zone. Further, when the relative humidity RHW is increased to be larger than 95%, the zone state is changed from B-zone to C-zone. On the other hand, when the relative humidity RHW is decreased to 90%, the zone state is changed from C-zone to B-zone. Further, when the relative humidity RHW of the windshield is decreased to 80%, the zone state is changed from B-zone to A-zone.

On the other hand, when the second engine operation request signal (second E/G ON signal) except for the air conditioner is not output or the hybrid vehicle 5 is in the stop state, the control of step S92 is performed through step S31, as shown in FIG. 24. At step S92, A-zone of a low humidity area, B-zone of a middle humidity area and C-zone of a high humidity area are set, and a zone determination is performed based on the relative humidity RHW in accordance with the characteristic view of step S92 pre-stored in the ROM. At step S92, the set value of the relative humidity RHW of the windshield 5a is set higher than that at step S91. That is, at step S92, when the relative humidity RHW is increased to be larger than 88%, the zone state is changed from A-zone to B-zone. Further, when the relative humidity RHW is increased to be larger than 98%, the zone state is changed from B-zone to C-zone. On the other hand, when the relative humidity RHW is decreased to 93%, the zone state is changed from C-zone to B-zone. Further, when the relative humidity RHW of the windshield 5a is decreased to 83%, the zone state is changed from B-zone to A-zone.

When the A-zone is determined at step S91 or at step S92, the third target post-evaporator temperature TE3 is set at 99° C., and thereafter, the final target post-evaporator TEO is calculated at step S33. Because it is unnecessary to perform dehumidifying operation for defrosting, the third target post-evaporator temperature TE3 is set at 99° C., and the compressor 41 is controlled to be stopped.

When the B-zone is determined at step S91 or S92, it is determined whether or not the relative humidity of the windshield 5a is decreased at step S94 by comparing the present relative humidity RHWn of the windshield 5a and a relative humidity RHWb before 4 seconds. When it is determined that the relative humidity of the windshield is decreased at step S94, it is determined whether or not a measured time of a timer B2 passes a predetermined time (e.g., 12 seconds) at step S95. Here, the measured time of the timer B2 is a passing time after the third target post-evaporator temperature TE3 is set at step 98. When it is determined that the measured time of the timer B2 does not pass the predetermined time (e.g., 12 seconds) at step S95, the count of the timer B2 is continuously performed at step S96, and thereafter, the control of step S97 is performed. That is, at step S97, the initialization of the other timers except for the timer B2 are performed. On the other hand, when it is determined that the measured time of the timer B2 passes the predetermined time (e.g., 12 seconds) at step S95, the third target post-evaporator air temperature TE3 is set at a value higher than a second target post-evaporator air temperature TE3b before 12 seconds by 0.35° C. (i.e., TE3=TE3b+0.35° C.) at step S98. Further, at step S98, the presently set third target post-evaporator air temperature TE3 is stored as the third target post-evaporator air temperature TE3b before 12 seconds, for the next time. Next, after the initialization of the timer B2 is performed at step S99, the control at step S97 is performed.

As described above, even in the B-zone of the middle humidity area, the third target post-evaporator air temperature TE3 is made higher when the humidity of the windshield is decreased. Accordingly, the stop range of the compressor 41 and the engine 1 is enlarged, while the pleasant performance of the passenger compartment is improved.

Next, when it is determined that the relative humidity of the windshield 5a is increased at step S94, it is determined whether or not a measured time of a timer B3 passes a predetermined time (e.g., 12 seconds) at step S100. Here, the measured time of the timer B3 is a passing time after the third target post-evaporator temperature TE3 is set at step S103. When it is determined that the measured time of the timer B3 does not pass the predetermined time (e.g., 12 seconds) at step S100, the count of the timer B3 is continuously performed at step S101, and thereafter, the control of step S102 is performed. That is, at step S102, the initialization of the other timers except for the timer B3 are performed. On the other hand, when it is determined that the measured time of the timer B3 passes the predetermined time (e.g., 12 seconds) at step S100, the third target poet-evaporator air temperature TE3 is set at a value lower than a third target post-evaporator air temperature TE3b before 12 seconds by 0.35° C. (i.e., TE3=TE3b−0.35° C.) at step S103. Further, at step S103, the presently set third target poet-evaporator air temperature TE3 is stored as the third target post-evaporator air temperature TE3b before 12 seconds, for the next time. Next, after the initialization of the timer B3 is performed at step S104, the control at step S102 is performed.

As described above, in the B-zone, the third target post-evaporator air temperature TE3 is made lower when the humidity of the windshield 5a is increased. Accordingly, the compressor 41 is operated so that the defrosting operation of the windshield 5a is performed. Therefore, the pleasant performance of the passenger compartment is maintained.

When the C-zone is determined at step S91 or step S92, it is determined whether or not a measured time of a timer C passes a predetermined time (e.g., 12 seconds) at step S105. Here, the measured time of the timer C is a passing time after the third target post-evaporator air temperature TE3 is set at step S108. When it is determined that the measured time of the timer C does not pass the predetermined time (e.g., 12 seconds) at step S105, the count of the timer C is continuously performed at step S106, and thereafter, the control of step S107 is performed. That is, at step S107, the initialization of the other timers except for the timer C are performed. On the other hand, when it is determined that the measured time of the timer C passes the predetermined time (e.g., 12 seconds) at step S105, the third target poet-evaporator temperature TE3 is set at a value lower than the present post-evaporator air temperature TE by 3° C. (i.e., TE3=TE−3° C.) at step S108. Next, after the initialization of the timer C is performed at step S109, the control at step S107 is performed.

As described above, in the C-zone of the high humidity area, the third target post-evaporator air temperature TE3 is made lower. Accordingly, the compressor 41 is controlled to be operated so that the defrosting operation of the windshield is performed. Therefore, the pleasant performance of the passenger compartment can be maintained in the C-zone.

According to the tenth embodiment, the set values for the zone determination at step S91 are different from that at step S92. Thus, when the second engine operation request signal (second E/G ON signal) except for the air conditioner is not output or when the hybrid vehicle 5 is in the stop state, the stop range of the compressor 41 and the engine 1 can be further enlarged, and the fuel economy performance can be further improved.

Although the present invention has been fully described in connection with the preferred embodiments thereof with reference to the accompanying drawings, it is to be noted that various changes and modifications will become apparent to those skilled in the art.

For example, in the above-described embodiments, the present invention is typically applied to the hybrid vehicle. However, the present invention can be applied to an economy vehicle having only a vehicle engine that is automatically stopped in a vehicle stop such as a case waiting for the signal.

In the above-described embodiments, the present invention is applied to the hybrid vehicle 5 in which the output of the engine 1 is directly used for the vehicle traveling. However, the present invention may be applied to a hybrid vehicle in which only the electrical motor 2 is always used for the vehicle traveling and the engine 1 is used for charging the battery 4 or driving the compressor 41.

In the above-described embodiments, the heater core 51 is used as a heating heat exchanger which heats air using engine-cooling water as a heating source. However, as a heating heat exchanger for heating air, a condenser of a refrigerant cycle may be used. Further, in the above-described embodiments, a four-way valve for reversely changing a refrigerant flow of a refrigerant cycle may be provided in the refrigerant cycle, so that an interior heat exchanger is used as a condenser and an exterior heat exchanger is used as an evaporator.

Such changes and modifications are to be understood as being within the scope of the present invention as defined by the appended claims.

What is claimed is:

1. An air conditioner for a vehicle having an engine that is operated when at least one of a first engine operation request signal from the air conditioner and a second engine operation request signal from a vehicle condition except for the air conditioner is output, and is stopped when both the first and second engine operation request signals are not output, the air conditioner comprising:
a compressor of a refrigerant cycle, for compressing refrigerant, the compressor being driven by the engine;
an evaporator cooling and humidifying air flowing into a passenger compartment of the vehicle, by evaporation latent heat of refrigerant of the refrigerant cycle; and
a control unit for controlling air state blown into the passenger compartment, wherein:
the control unit includes compressor control means which determines a pleasant performance based on a humidity of air in the passenger compartment and determines whether or not operation of the compressor is necessary;
when the compressor control means determines that the operation of the compressor is necessary, the control unit outputs the first engine operation request signal; and
the compressor control means changes a determination level whether or not the compressor operates, so that a stop range of the compressor, when the second engine operation request signal is not output, is made wider than that when the second engine operation request signal is output.

2. The air conditioner according to claim 1, wherein:
the control unit determines a control target temperature of air at a position immediately after the evaporator, by comparing an actual humidity and a control target humidity of air in the passenger compartment; and
the compressor control means changes the control target humidity as the determination level to a high humidity side when the second engine operation request signal is not output, as compared with a case where the second engine operation request signal is output.

3. The air conditioner according to claim 1, wherein:
the control unit determines a control target temperature of air at a position immediately after the evaporator, by comparing an actual humidity and a control target humidity of air in the passenger compartment; and
the compressor control means changes the control target temperature as the determination level to a high temperature side when the second engine operation request signal is not output, as compared with a case where the second engine operation request signal is output.

4. The air conditioner according to claim 3, wherein:
the control unit divides a range of humidity of air in the passenger compartment into a first humidity area lower than a first predetermined humidity, a second humidity area between the first predetermined humidity and a second predetermined humidity higher than the first predetermined humidity, and a third humidity area higher than the second predetermined humidity; and
the control target temperature is changed per each of the first, second and third humidity areas.

5. The air conditioner according to claim 4, wherein,
in the first humidity area, the control target temperature is gradually changed to be increased as time passes.

6. The air conditioner according to claim 4, wherein,
in the second humidity area, the control target temperature is changed in accordance with a change tendency of the humidity of air inside the passenger compartment.

7. The air conditioner according to claim 6, wherein the control target temperature is increased when the humidity of air inside the passenger compartment is decreased.

8. The air conditioner according to claim 6, wherein the control target temperature is decreased when the humidity of air inside the passenger compartment is increased.

9. The air conditioner according to claim 4, wherein,
in the third humidity area, the control target temperature is gradually changed to be decreased as time passes.

10. The air conditioner according to claim 1, wherein:
when the vehicle is in a stop state, the output of the second engine operation request signal is stopped.

11. An air conditioner for a vehicle having an engine that is operated when at least one of a first engine operation request signal from the air conditioner and a second engine operation request signal from a vehicle condition except for the air conditioner is output, and is stopped when both the first and second engine operation request signals are not output, the air conditioner comprising:
a compressor of a refrigerant cycle, for compressing refrigerant, the compressor being driven by the engine;
an evaporator cooling and humidifying air flowing into a passenger compartment of the vehicle, by evaporation latent heat of refrigerant of the refrigerant cycle; and
a control unit for controlling air state blown into the passenger compartment, wherein:
the control unit includes compressor control means which determines a fogging state of a windshield based on a humidity of air inside the passenger compartment and determines whether or not operation of the compressor is necessary;
when the compressor control means determines that the operation of the compressor is necessary, the control unit outputs the first engine operation request signal; and
the compressor control means changes a determination level whether or not the compressor operates, so that a stop range of the compressor, when the second engine operation request signal is not output, is made wider than that when the second engine operation request signal is output.

12. The air conditioner according to claim 11, wherein:
the control unit determines a control target temperature of air at a position immediately after the evaporator, by comparing an actual humidity and a control target humidity of air on the windshield; and
the compressor control means changes the control target humidity as the determination level to a high humidity side when the second engine operation request signal is not output, as compared with a case where the second engine operation request signal is output.

13. The air conditioner according to claim 11, wherein:
the control unit determines a control target temperature of air at a position immediately after the evaporator, by comparing an actual humidity and a control target humidity of air on the windshield; and
the compressor control means changes the control target temperature as the determination level to a high temperature side when the second engine operation request signal is not output, as compared with a case where the second engine operation request signal is output.

14. The air conditioner according to claim 13, wherein:
the control unit divides a range of humidity of air on the windshield into a first humidity area lower than a first predetermined humidity, a second humidity area between the first predetermined humidity and a second predetermined humidity higher than the first predetermined humidity, and a third humidity area higher than the second predetermined humidity; and
the control target temperature is changed per each of the first, second and third humidity areas.

15. The air conditioner according to claim 14, wherein,
in the first humidity area, the control target temperature is gradually changed to be increased as time passes.

16. The air conditioner according to claim 14, wherein,
in the second humidity area, the control target temperature is changed in accordance with a change tendency of the humidity of air on the windshield.

17. The air conditioner according to claim 16, wherein the control target temperature is increased when the humidity of air on the windshield is decreased.

18. The air conditioner according to claim 16, wherein the control target temperature is decreased when the humidity of air on the windshield is increased.

19. The air conditioner according to claim 14, wherein,
in the third humidity area, the control target temperature is gradually changed to be decreased as time passes.

20. The air conditioner according to claim 11, wherein the control unit switches a first dehumidifying mode where air is blown toward the windshield while the compressor stops, and a second dehumidifying mode where air is blown toward the windshield while the compressor operates, based on the humidity of air on the windshield.

21. The air conditioner according to claim 20, wherein:
in the first dehumidifying mode, an air amount blown toward the windshield is controlled in accordance with an outside air temperature.

22. The air conditioner according to claim 20, wherein:
in the first dehumidifying mode, an air amount blown toward the windshield is controlled in accordance with an air temperature blown into the passenger compartment.

23. The air conditioner according to claim 20, wherein the engine is a water-cooled type, the air conditioner further comprising
a heater core for heating air to be blown into the passenger compartment using cooling water for cooling the engine as a heating source, wherein:
in the first dehumidifying mode, an air amount blown toward the windshield is controlled in accordance with a temperature of cooling water of the engine.

24. The air conditioner according to claim 20, wherein:
in the first dehumidifying mode, an air amount blown toward the windshield is controlled in accordance with the humidity of air on the windshield.

25. An air conditioner for a vehicle having an engine that is operated when at least one of a first engine operation request signal from the air conditioner and a second engine operation request signal from a vehicle condition except for the air conditioner is output, the output of the second engine operation request signal being stopped when the vehicle is in a stop state, the air conditioner comprising:
a compressor of a refrigerant cycle, for compressing refrigerant, the compressor being driven by the engine;
an evaporator cooling and humidifying air flowing into a passenger compartment of the vehicle, by evaporation latent heat of refrigerant of the refrigerant cycle; and
a control unit for controlling air state blown into the passenger compartment, wherein:
the control unit includes compressor control means which determines a pleasant performance based on a humidity of air in the passenger compartment and determines whether or not operation of the compressor is necessary;
when the compressor control means determines that the operation of the compressor is necessary, the control unit outputs the first engine operation request signal; and
the compressor control means changes a determination level whether or not the compressor operates, so that a stop range of the compressor, when the vehicle is in the stop state, is made wider than that when the vehicle is in a travelling state.

26. An air conditioner for a vehicle having an engine that is operated when at least one of a first engine operation request signal from the air conditioner and a second engine operation request signal from a vehicle condition except for the air conditioner is output, the output of the second engine operation request signal being stopped when the vehicle is in a stop state, the air conditioner comprising:
a compressor of a refrigerant cycle, for compressing refrigerant, the compressor being driven by the engine;
an evaporator cooling and humidifying air flowing into a passenger compartment of the vehicle, by evaporation latent heat of refrigerant of the refrigerant cycle; and
a control unit for controlling air state blown into the passenger compartment, wherein:
the control unit includes compressor control means which determines a fogging state of a windshield based on a humidity of air on the windshield and determines whether or not operation of the compressor is necessary;
when the compressor control means determines that the operation of the compressor is necessary, the control unit outputs the first engine operation request signal; and
the compressor control means changes a determination level whether or not the compressor operates, so that a stop range of the compressor, when the vehicle is in the stop state, is made wider than that when the vehicle is in a travelling state.
